(19) United States
(12) Patent Application Publication
(10) Pub. No.: US 2006/0136274 A1
(43) Pub. Date: Jun. 22, 2006

(54) System, method, and apparatus for providing a single-entry and multiple company interface (SEMCI) for insurance applications and underwriting and management thereof

(76) Inventors: Lyle Eric Olivier, North Ridgeville, OH (US); Al Eskanazy, Roslyn Harbor, NY (US); Denise Careri, Palisades Park, NJ (US); Frank Intoci, West Islip, NY (US); Robert Goldfarb, North Massapequa, NY (US); David L. Perish, Cleveland, OH (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/225,266

(22) Filed: Sep. 12, 2005

Related U.S. Application Data
(60) Provisional application No. 60/609,201, filed on Sep. 10, 2004.

(51) Int. Cl. G06Q 40/00

(52) U.S. Cl. 705/4

(57) ABSTRACT

A system, method, and apparatus provides a real-time single-entry, multiple company interface (SEMCI) that allows users to complete applications via in an automated and efficient manner. data is collected in standard forms and stored in a database managed by a Managing General Agency (MGA). Underwriting personnel at the MGA can also enter client data on behalf of a User or unregistered Broker in a variety of scenarios. The Underwriter processes the application by performing real-time rating, binding, and policy issuance functions. Documents are communicated automatically using built-in communications functions. Automated system generated notes, non-automated user generated notes, and tracking and information control panels are provided. Automated reassignment of pending matters is enabled. Automated Endorsement, Renewal Application and Cancellation Request management systems exist. Online enrollment and re-authentication systems provide access to the data entry forms and document repository to retrieve and manage client information.

### CROSS REFERENCE TO RELATED APPLICATIONS

This application claims priority from U.S. Provisional App. No. 60/609,201 filed Sep. 10, 2004, the entire contents of which are incorporated herein by reference.

### BACKGROUND OF THE INVENTION

1. Field of the Invention

The present invention relates to a system, method, and apparatus providing a single-entry, multiple company interface (SEMCI) for insurance applications and underwriting and management thereof by one or more Managing General Agencies or Intermediaries (MGA's).

More specifically, the present invention relates to a system, method and program providing a real-time internet based single-entry, multiple company interface (SEMCI) that allows Insurance Agents/Brokers/Producers (Users) to complete insurance applications via the internet on behalf of prospective clients.

Client data is collected in insurance industry standard forms such as those provided by the Association for Cooperative Operations Research (ACORD), and stored in a database managed by a Managing General Agency or Intermediary (MGA). The User then submits the application data to the MGA for processing. Underwriting personnel at the MGA can also enter client data on behalf of a User or unregistered Broker in the case the application was submitted via Electronic Mail (Email) or Facsimile (Fax).

Upon review of the submitted application, the Underwriter can process the application by performing real-time rating, binding, and policy issuance functions by accessing integrated software provided by designated software solutions providers. Documents are communicated to Users, Insurance Providers, and Inspection Service Providers using built-in Internet, Email or Fax communications functions.

Upon completion of all Underwriting tasks, documents are archived and data is transmitted to internal accounting and billing software provided by designated software solutions providers. The system, method and program also allows for Endorsement, Renewal Application and Cancellation Request management. An online enrollment and re-authentication means is provided for Users to access the data entry application forms and document repository to retrieve and manage client information.

2. Description of the Related Art

The related art involves a plurality of related processes and systems for selected aspects of the insurance business. Selected examples of such related processes and systems fail to include the novel aspects discussed herein, but are supplied below and incorporated fully herein to aid the reader in grasping the overall concepts discussed.

In a first example, US Pub. No. 20010049611 to Peach provides a system and method for electronically acquiring and distributing insurance policy data to broker offices, the contents of which are fully incorporated herein by reference. As noted in Peach, while selected client data is entered into insurance industry standardized forms, such as those provided by the Association for Cooperative Operations Research (ACORD), such data entry is well known as responding to data inquiry requests, and fails to disclose the unique data-stamp validation and tracking elements discussed herein.

In an additional example of a related art reference, US Pub. No. 20020138310 to Sagalow, the contents of which are fully incorporated herein by reference, the inventor provides a process for online sale of an internet insurance products in a very brief three-page discussion but fails to focused on the present invention and instead is customer-focused allowing a customer to select an insurance desired and apply for the same. Unfortunately, Sagalow fails to recognize the needs within the insurance management and intermediate underwriting, binding, and tracking management areas.

On an additional example, US Pub. No. 20040078243 to Fischer, the contents of which are fully incorporated herein by reference, the inventor discusses an automatic insurance processing method wherein an end-insured completes an insurance request form and emails the same for later review and underwriting and return after underwriting. Unfortunately, Fischer fails to address the industry specific needs noted below for an efficient and effective management of a secure underwriting insurance system.

In another additional example noted in US Pub. No. 20020120476 to Labelle et al., the contents of which are fully incorporated herein by reference, the inventors discuss a system and method of dispensing insurance through a computer network. While Labelle does provide electronic distribution of insurance products it fails in completing the essential security and management aspects provided herein.

In a further related example noted in US Pub. No. 20020194033 to Huff, the contents of which are fully incorporated herein by reference, the inventor discusses an automatic insurance data extraction and quote generating system and methods therefore.

In a final related example noted at http://www.insurancenoodle.com/Products/licensing/index.asp, provided by “Insurance Noodle” the contents of which are fully incorporated herein by reference, the inventors provide various data entry, and risk appetite programs for license and also discuss the cross-incorporation of insurance billing and insurance services.

What is not appreciated by the related art is the need for an insurance management system providing the improvements enabled by the present disclosure.

Accordingly, based upon the limited related art and its inability to provide a comprehensive electronic insurance application receipt, tracking, underwriting, binding, and issuing system, there is a need for an improved system, method, and apparatus providing a single-entry, multiple company interface (SEMCI) for insurance applications and underwriting and management thereof having at least one of the following benefits:
(a) A stream lined MGA system minimizing human administration costs throughout the insurance request, broker, underwriting, binding, and issuance process.
(b) A unique User Identification electronically track-able and linked with a date and time of access.
(c) The use of a unique User Identification in concert with a Verification system wherein a email reflection generated during initial user access supplies a special-user-identification linked code for security and tracing applications downstream.
(d) A ready integration of a plurality of private previously-non-authorized insurance providers with the MGA and the assignment of an administrator status to an initial user from the previously non-authorized insurance provider to facilitate downstream use.
(e) A User Identification system tracking a company linked with the User Identification [hereinafter U-id] and the U-id's activities throughout the system.
(f) An automated assignment of “administrator” management status via a user-identification and access process.
(g) Minimize the loss of “unusual” applications and those applications otherwise lost or trapped within an application tracking system or requiring additional information or input.
(h) To minimize the generation of duplicate of ghost applications or preliminary quotations and underwritings within an overall insurance issuance and managing system.
(i) A system enabling tracking by a MGA of a User and Broker Company of every application and response to thereby manage and reassign underwriting traffic at bottle-neck areas to speed insurance quotation and underwriting.
(j) A system enabling the MGA to split up applications, edit, and reclassify applications in situ (during quotation, underwriting, binding, and issuance) to manage ratings, quote, and other items necessary to bind and issue policies in an accurate and speedy manner with up-to-date information.
(k) Allowing an authenticated user to select a desired broker company from a geographic location/selection format enabling independent insurance agents to readily interface with an over-arching MGA enabler.
(l) A system enabling administrators and MGA's to set up new company information pages to list a plurality of insurance brokers as web page access portals so that authorized users may access pages from diverse locals via LAN/WAN/WiFi-Max, etc., thereby speeding a quotation process.
(m) A system enabling the use of a user message center allowing brokers and users to ender meaningful data linked to an application or request, for example the notation of a best contact, urgent deadline, alternative contact information or other data.
(n) Enable a continual “status identifier” for each application form noting a completion or incomplete status to aid the user and minimize the unintended submission of incomplete applications.
(o) Allow the generation, tracking, and management of “electronic notes” on each underwriting and application page that are created detailing the date and time each task was completed, who performed the task and what was performed, as well as any additional follow-up matters. This electronic note feature aids substantially to the speed and continuity of each application/endorsement request. Administrators may allow or dis-allow visual access to these notes to manage the process flow.
(p) Provide, on multiple screens and at a minimum on every selected endorsement request page, the Underwriter is presented with a “control panel” detailing the client's name, the Broker's name and phone number, the Coverage Types, proposed effective and expiration dates, Endorsement Request status, and all supporting documents created during the process.

### OBJECTS AND SUMMARY OF THE INVENTION

An object of the present invention is to provide an enabling system providing at least one of the benefits noted above

Another object of the present invention is to provide a unique user identifier is linked with a time/date of use and cross-linked with an authorized broker company enabling the MGA to track and manage submissions and submission performance criteria down stream.

The present invention relates to a system, method and apparatus or program providing a real-time internet based single-entry, multiple company interface (SEMCI) that allows definable users, namely Insurance Agents/Brokers/Producers (Users) to complete insurance applications via the internet on behalf of prospective clients. Client data is collected in insurance industry generally standard forms such as those provided by the Association for Cooperative Operations Research (ACORD) or in custom-generated forms, and stored in a database managed by a selected Managing General Agency or Intermediary (MGA).

As considered in one preferred embodiment, the User then submits the application data to the MGA for processing. Underwriting personnel at the MGA can also enter client data on behalf of a User or unregistered Broker in the case the application was submitted via Electronic Mail (Email) or Facsimile (Fax) in other ways developed in the electronic media.

Upon review of the submitted application, the Underwriter can process the application by performing real-time rating, binding, and policy issuance functions by accessing integrated software provided by designated software solutions providers. Thereafter, documents are communicated to Users, Insurance Providers, and Inspection Service Providers using built-in Internet, Email or Fax communications functions. Upon completion of all Underwriting tasks, documents are archived and data is transmitted to internal accounting and billing software provided by designated software solutions providers.

The system, method and program apparatus discussed here in a preferred embodiment also allows for simplified and streamlined Endorsement, Renewal Application and Cancellation Request management. An online enrollment and re-authentication means is provided for Users to access the data entry application forms and document repository to retrieve and manage client information.

According to an embodiment of the present invention there is provided a system for providing a real-time single-entry, multiple company interface (SEMCI) allowing users to complete applications for insurance as managed by a Managing General Agency (MGA), the system configured to: provide an automated user registration and authentication process supplying a unique-user identification and validation system to a user, the automated user registration process includes an automated unique-user tracking apparatus and means for enabling the unique-user tracking apparatus to link the user to each action of the user for an improved system management, the automated user registration process including means for linking a broker company to the unique-user identification prior to an authentication of the user as a broker, provide an automated user application creation and submission process for supplying insurance submission data and for creating and submitting an insurance endorsement request application to an underwriter for review, provide a means for automating a submission management process for analyzing and underwriting an insurance endorsement request application submitted to an underwriter for review, the means for automating a submission management process further including means for conducting a rating of the insurance endorsement request, the means for conducting a rating including means for conducting one of an automated and a manual rating of the insurance endorsement request, and provide a means for automatically enabling the underwriter to transmit the insurance endorsement request to the broker following a rating result and an endorsement of the insurance request.

According to another embodiment of the present invention there is provided a system for providing a real-time single-entry, multiple company interface (SEMCI) allowing users to complete applications for insurance as managed by a Managing General Agency (MGA), the system wherein: the submission management process includes means for an underwriter to designate additional application information as needed, the additional application information being categorized as critical or general application information, whereby missing the critical application information prohibits the system from further action on the application for insurance thereby improving an accuracy and a speed of the system.

According to another embodiment of the present invention there is provided a system for providing a real-time single-entry, multiple company interface (SEMCI) allowing users to complete applications for insurance as managed by a Managing General Agency (MGA), the system configured to: contain means for generating at least one of a system generated note and a non-system generated note at each action along a complete application chain, the at least one note being generated by an action of at least one of a user, and underwriter, and a broker, whereby the at least one generated note is electronically linked with the action of the at least one and reviewable at least the underwriter thereby enabling the underwriter to be informed of selected application information notes during an underwriting process.

According to another embodiment of the present invention there is provided a system for providing a real-time single-entry, multiple company interface (SEMCI) allowing users to complete applications for insurance as managed by a Managing General Agency (MGA), the system configured to: contain means for generating and updating a control panel system providing selectable options to one of the underwriter and the broker to track a process during the underwriting

According to another embodiment of the present invention there is provided a system for providing a real-time single-entry, multiple company interface (SEMCI) allowing users to complete applications for insurance as managed by a Managing General Agency (MGA), the system configured to: provide an endorsement request processing system for managing an underwriter system processing system and for tracking and generating management data for tracking the underwriter system.

According to another embodiment of the present invention there is provided a system for providing a real-time single-entry, multiple company interface (SEMCI) allowing users to complete applications for insurance as managed by a Managing General Agency (MGA), the system configured to: provide an application renewal processing system including means for receiving a renewal request and for conducting one of an automatic renewal and a non-automatic renewal, whereby the system substantially automates a renewal process.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1A and FIG. 1B are a combined process description chart of one embodiment of an Automated User Registration Process as disclosed herein.

FIG. 2A and FIG. 2B are a combined process description chart of one embodiment of an Automated User Re-Authentication Process as disclosed herein.

FIG. 3 provides a process description chart for one embodiment of a User Application Creation and Submission Process as disclosed herein.

FIGS. 4A through 4C are a combined process description chart of one embodiment of one aspect of an Underwriter System, specifically the Submission Management Process for Underwriting as disclosed herein.

FIGS. 5A through 5C are a combined process description chart of one embodiment of an Endorsement Request Processing System as disclosed herein.

FIGS. 6A through 6C provide a combined process description chart of one embodiment of a Renewal Process Management System as disclosed herein.

### DETAILED DESCRIPTION OF THE PREFERRED EMBODIMENT

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Automated User Registration Process

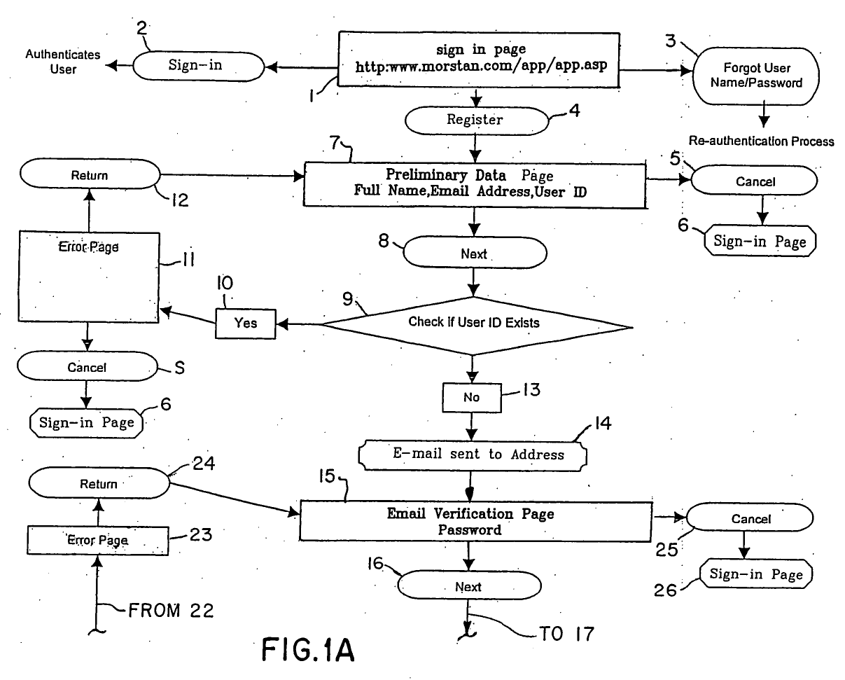

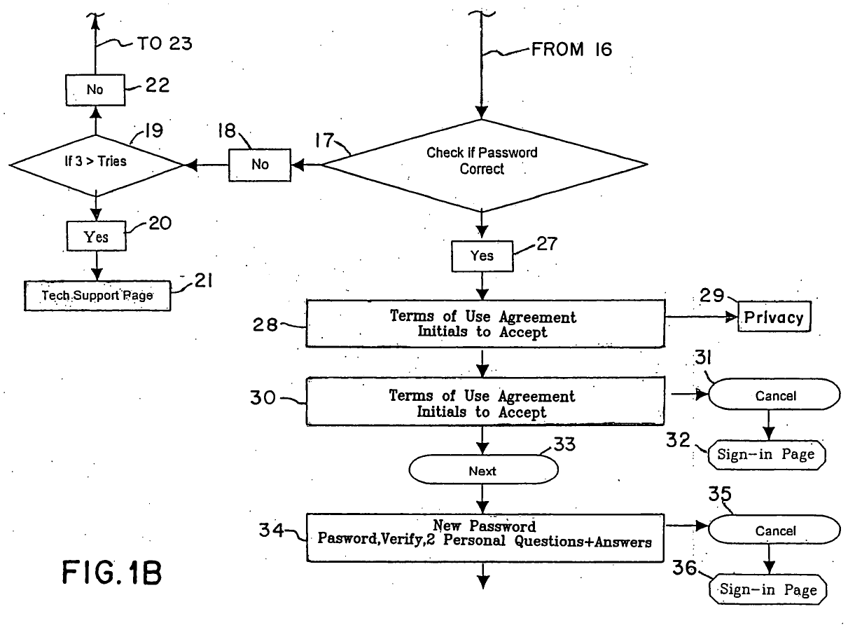

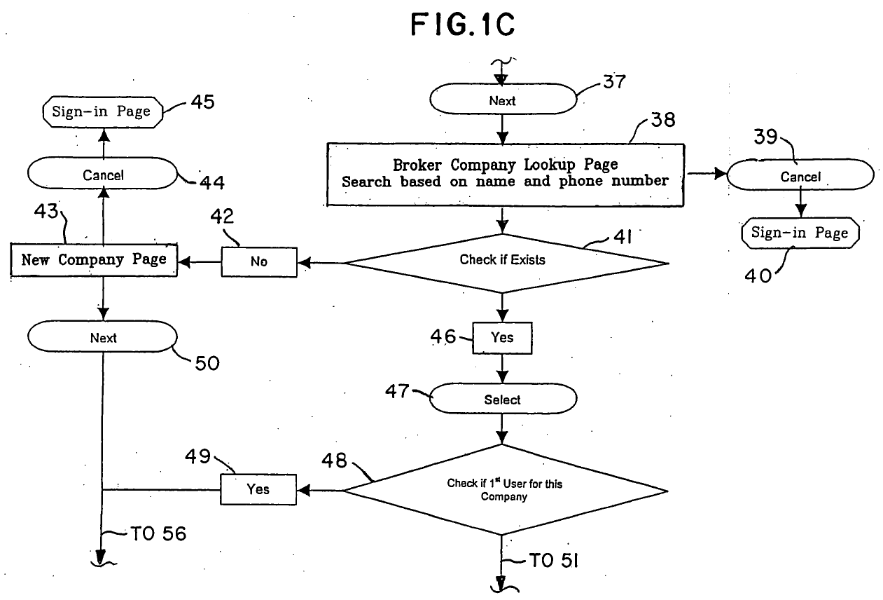

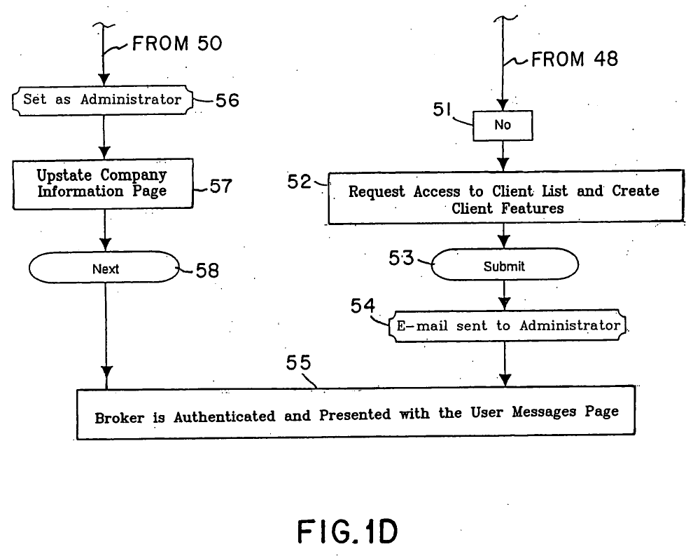

Referring now to FIGS. 1A and 1B, an automated user registration process will be discussed.

As discussed herein, the automated registration process contains six (6) core steps required to “authenticate” a Broker to allow access to the system. Access to the registration process begins from the Sign-In page located on the MGA website by selecting the Register button, as will be discussed.

In a first step, noted in elements 1 through 14 a unique user identification system is noted in FIG. 1A. As noted in steps 1-14, users are presented with the Preliminary Data page 1 or Start page requesting the User's full name, email address, and a user name. Users are given the option to Cancel 5 the process and return to Sign-In page 6.

When the User completes the requested information and chooses to proceed, the system validates that the requested information was entered, and in the correct format. Additionally, the system validates the user name entered to make sure that no other user of the system is using the same user name. Appropriate messages are displayed if any information is invalid. If all data passes the validation, an email is generated (step 14) by the system containing a special code and sent to the email address entered. A new user record is created in the database and the User is directed to the next step.

In a second step, noted in elements 15 through 27, users are presented with the Verification page 15 requesting the special code contained in the email. The User is given the option to cancel the process at 25-26. If selected, they are presented with an option to return to the registration process or Sign-In page.

If the User attempts to sign-in with the code supplied in the email, they will automatically be placed back into the registration process. Once the code is entered on the Verification page, validation is performed. If the code does not match the code sent in the email, the User is presented with an error page that allows them to return and try again. User is allowed 3 failed attempts before being disallowed to continue. If the code passes the validation, the User is directed to the next step 27.

In a third step, noted in elements 28 through 36, users are presented with the Terms of Use Agreement 28 and with access to a Privacy Statement 29. The User is given the option to Cancel the process. If selected, they are presented with an option to return to the registration process or Sign-In page. If the User attempts to sign-in with the code supplied in the email, they will automatically be placed back into the registration process.

As a safety feature, users are required to accept the agreement by entering their initials in order to proceed. Validation is performed to make sure that initials are entered before being allowed to proceed. Appropriate error messages are displayed if validation fails. If validation passes, the system updates the Users data with the entered information and records the date and time the agreement was accepted. Obviously, thereafter the User is presented with the next step.

As noted herein, the present invention provides a unique time/date, user stamp for each access event and a unique traceable acceptance to a potentially frequently changed Terms of Use and Privacy statement. By tracking authorization at each stage with a unique user/time/date stamp the present system enables a comprehensive tracking for MGA protection.

In a fourth step noted also within elements 28 through 36, users are presented with a Password page 34 requesting the creation of a password and are furthermore required to verify the password by entering it in again. Additionally, Users are required to select 2 personal questions from drop down lists. These questions are required for re-authentication in the case that a User has forgotten their user name or password. The answers to the 2 questions must also be entered.

Thereafter, the User is given the option to cancel the process. If selected, they are presented with an option to return to the registration process or Sign-In page. If the User attempts to sign-in with the code supplied in the email, they will automatically be placed back into the registration process. Validation is performed on entered data. If data fails validation, appropriate error messages are displayed. If data passes validation, the system updates the user record with the entered data and the User is directed to the next step 37.

In a fifth step, discussed through elements 38 through 58, users are presented with a Broker Company Look-up Page 38 requesting the name of the company the User is an employee of and the pre-entered phone number. The User is not allowed to cancel at this point. However, if the User does not proceed and they try to sign-in, they will be brought back into the registration process.

A validation sequence is performed to make sure data is entered correctly. Appropriate error messages are displayed if data fails validation. If data passes validation, a search is performed on the system database to check if the company entered matches any of the currently registered companies.

As noted in the drawing, if no match is found, the User is presented with a link to Add a New Company at step 43, thereby allowing ready incorporation of new insurance agents, brokers, and providers within the overall MGA system.

When selected, the New Company page is displayed requiring company specific data. Validation is performed on entered data. If data fails validation, appropriate error messages are displayed. If data passes validation, the system adds a new company record, updates the user record, and the User is directed to the next step.

If a match is found, the User is presented with a list of the possible matches. The User is thereafter required to select the appropriate company to proceed. Once a company is selected the User is directed to the next step.

As one of the advantages provided by the present invention, a unique user identifier is linked with a time/date of use and cross-linked with an authorized broker company enabling the MGA to track and manage submissions and submission performance criteria down stream.

In a sixth step, users are presented with the Confirmation page. At this point, the User is now authenticated and may proceed as will be discussed more fully below.

As one of the unique advantages provided by the present system, if the “User” is the first to register the company into the system as described above, the envisioned system automatically assigns “Administrator rights”, and an email is sent to an Employee at the MGA requesting access to the system. Once granted, an email is sent to the User advising of the approval to access the system. (See discussion of “Administrators” below).

If the User is assigned to (or selects a link to) an already registered company, they are not automatically granted full access to the system. Instead they are presented with an option to request access to the system from the Administrator. If selected, an email is sent to the Administrator for the selected company requesting access to the system.

As envisioned under the present overall MGA system discussed above, one of the advantages is that Administrator rights are assigned automatically during the registration process if the User registering is the first to register the company. Only 1 Administrator is allowed per registered company. Administrators are automatically granted full access to the system upon the completion of the registration process. Administrators have access to perform the following tasks:
1. Manage the access rights. Administrators can Grant or Revoke access to the system to users who register to the company.
2. Manage company information. Administrators can update their company information.
3. Re-assign Administrator rights. Administrators can re-assign their rights to another registered user for their company.
4. Administrators also serve as the default person email notifications and other communications are sent to in the case that the system attempts to communicate with a person whose access has been revoked.

Thus, the present system provides for automatic management of administrator-status assignment, which greatly aids and streamlines the present invention when compared to the related references.

Automated User Re-Authentication Process

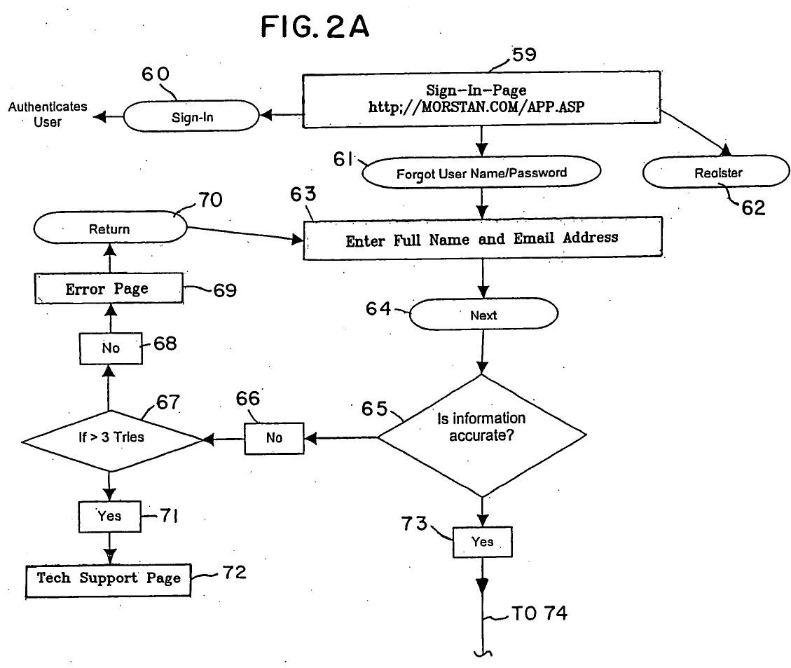

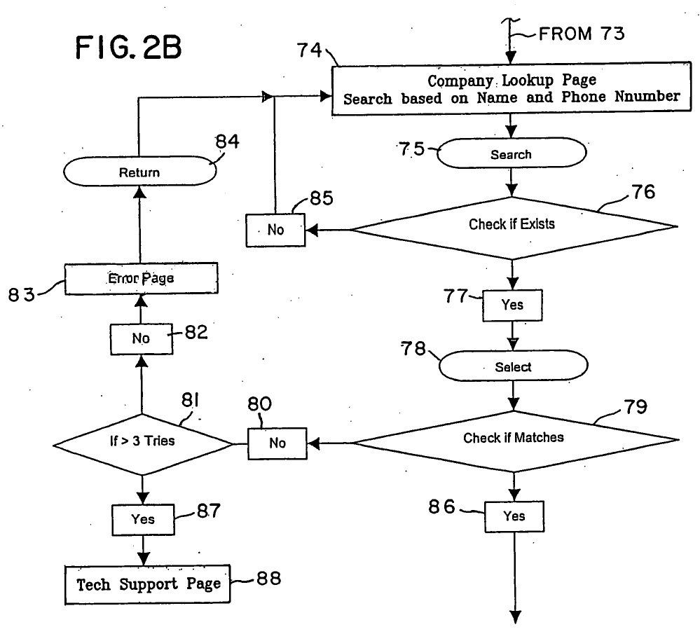

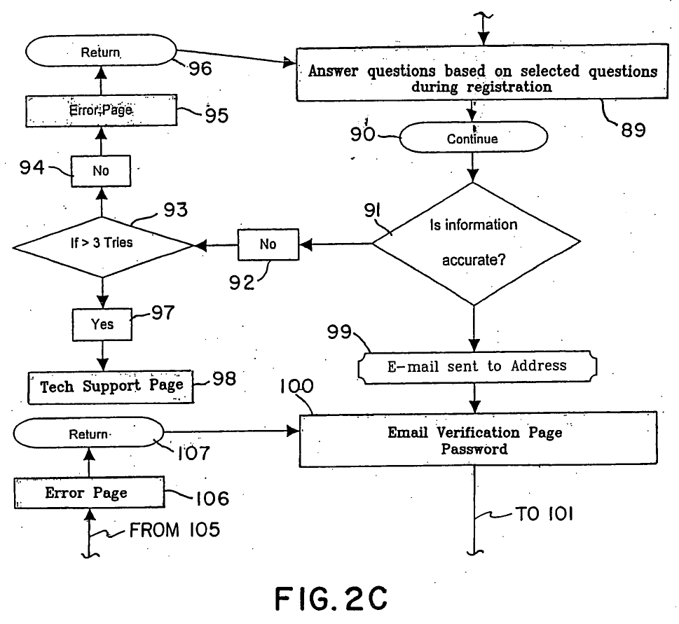

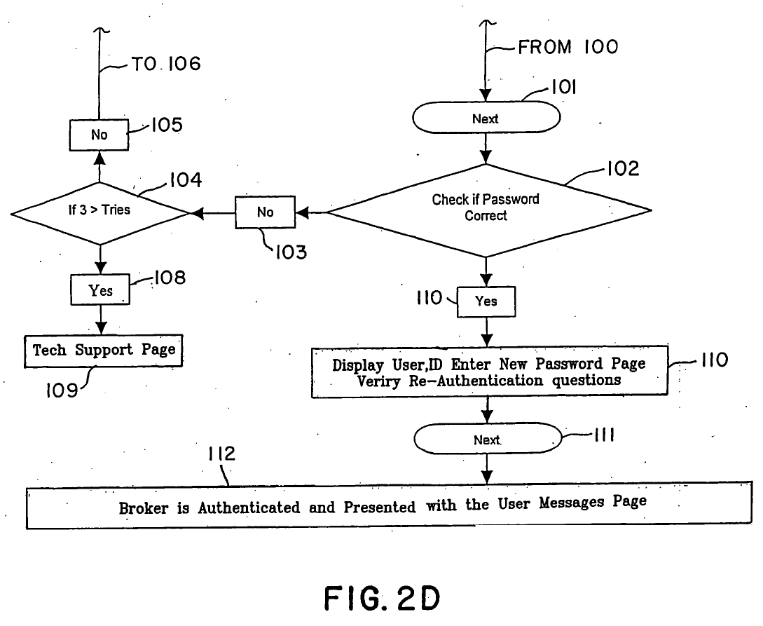

Referring now to FIGS. 2A and 2B and steps 59 through 112, an automated re-authentication process contains sic (6) core steps required to authenticate a User to allow access to the system. Access to the re-authentication process begins from the Sign-In page located on the MGA website by selecting a “Forgot User ID” or “Forgot Password” link supplied at element 61.

In the first step of the automated user re-authentication process, users are presented with the Personal Information page requesting their full name and email address as they were originally entered at time of registration (discussed above).

Users are thereafter given the option to cancel the process. If selected, they are returned to the Sign-In page. When the User completes the requested information and chooses to proceed, the system validates that the requested information was entered, and in the correct format and initiates tracking the route the user employs through the system. Appropriate messages are displayed if validation fails.

If validation passes, the system searches for a matching user record at step 74-88. If not found, an error page is displayed. A limit of 3 failed attempts is set and if reached, the User is requested to contact technical support. If a user record is found, the User is presented with the next step.

In the second step of the Automated User Re-Authentication Process, users are presented with the Company Information page requesting the name and phone number of the company selected at time of registration. Users are not given the option to cancel. Validation is performed on the entered data.

As earlier discussed, appropriate messages are displayed if validation fails. If validation passes, the system searches for a matching company record and displays a list of possible matches. The user is required to select the company form the list to proceed. Upon selection, the system verifies that the company selected is indeed the company selected at time of registration. If the company does not match, the user is allowed 3 failed attempts after witch they are requested to contact technical support. If the company selected matches the company selected at time of registration, the User is presented with the next step (step 86).

In a third step of the automated user re-authentication process, users are presented with the questions page (element 89) where the two “personal” questions selected at time of registration are presented. Users are required to supply the answers to these questions. Users are given the option to cancel. If selected, they are returned to the Sign-In page.

Validation is performed on the entered data and if fails, appropriate messages are displayed. If validation passes, the system verifies that the entered data matches the information entered at time of registration. The User is allowed three failed attempts after which, they are directed to contact technical support. If verification succeeds, an email is sent to the email address entered at time of registration containing a special code. The system resets the User's password and the User is presented with the next step. As a consequence of this step security is heightened by continually resetting a user's password in the manner illustrated.

In a fourth step of an automated user re-authentication process, users are presented with the Verification page (element 100) requesting the special code contained in the email. The User is given the option to cancel the process. If selected, they are presented with an option to return to the re-authentication process or Sign-In page. If the User attempts to sign-in with the code supplied in the email, they will automatically be placed into the registration process. Once the code is entered on the Verification page, validation is performed.

If the code does not match the code sent in the email, the User is presented with an error page that allows them to return and try again. User is allowed three failed attempts before being disallowed to continue. If the code passes the validation, the User is directed to the next step.

In a fifth step of an automated user re-authentication process, in a manner described earlier and shortened herein, users are presented with the Password page requesting the creation of a new password and are required to verify the password by entering it in again. Additionally, users are presented with their User ID, and are required to check the two personal questions selected at time of registration. The User is given the option to Cancel the process. If selected, they are presented with an option to return to the registration process or Sign-In page. If the User attempts to sign-in with the code supplied in the email, they will automatically be placed back into the registration process. Validation is performed on entered data. If data fails validation, appropriate error messages are displayed. If data passes validation, the system updates the user record with the entered data and the User is authenticated and has access to the system.

In a sixth step of an automated user re-authentication process, a User ID and Password are required to gain access to the system. The User creates these during the registration process earlier discussed. The Sign-In page requires that the user provide their unique User ID and Password. The system verifies entered data with data stored in the database. The user is permitted three failed attempts at sign-in after which, the user is directed to contact technical support. If the password entered matches the special code sent in the email at time of registration or re-authentication, the user is directed to the Terms of Use agreement and required to complete the registration process. Similarly, if the user is not assigned to a company, they are directed to the Terms of Use agreement and required to complete the registration process. Upon successful authentication, the user is presented with the Messages page. The system automatically detects Administrator status of the authenticated user.

Referring now to element 112 on FIG. 2B, a user message center is accessed via a Messages Page presented to users of the system upon successful authentication after (a) Sign-In, (b) Registration and/or (c) Re-Authentication.

As discussed herein, this feature displays two principal types of messages but others are envisioned; namely “User Messages” and “System Messages”. In each case such messages will enable a comprehensive linked insurance package available to the MGA and users to speed the insurance process.

It is envisioned herein, that “User Messages” contain all messages for normal users and in a tailored manner, will display Administrator-type messages only to those users designated by the system as an Administrator. Messages are created and creatable in the “Administration Tool” section described below.

User Application Creation and Submission Process

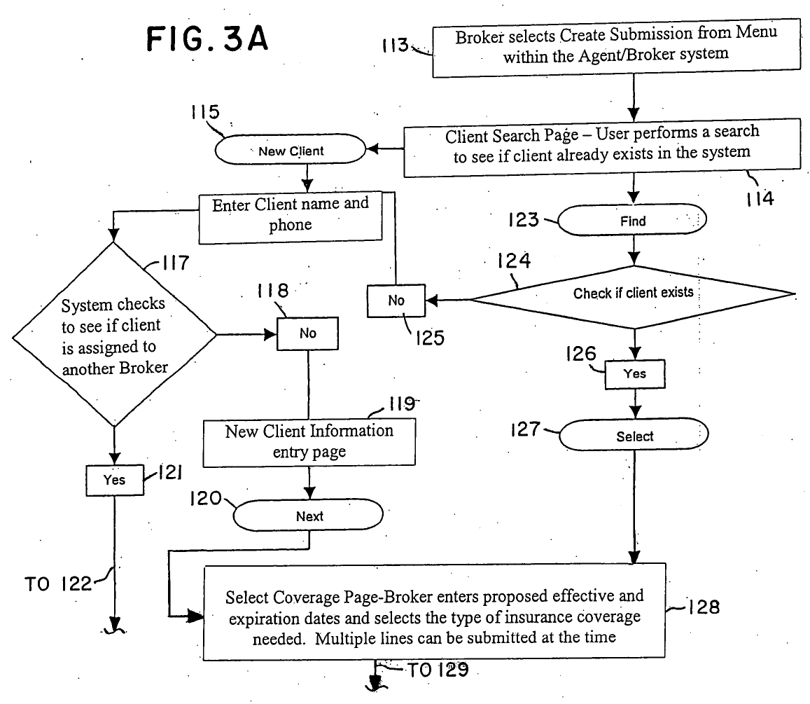

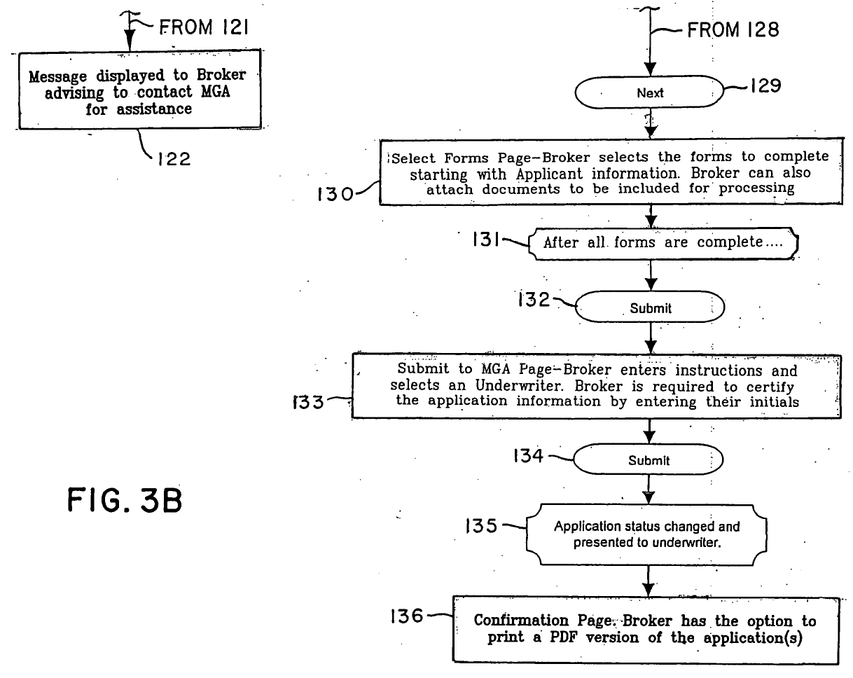

Referring now to FIG. 3 and elements 113 through 136 the present invention provides several particular characteristics; including (a) key point verification and system checking in steps in 114-122 to confirm that a client does exist and all required information is entered and (b) that a special broker certification is provided asserting that the information is accurate and authentic. Each step provides the benefit of speeding processing and shifting responsibility to the initial data user while easing an overall management function.

As discussed herein, the submission process contains four (4) core steps to complete a New or Renewal Submission and submit the same to the MGA for continued processing. As discussed herein, access to the application process is restricted to “Administrators” and those users that have been granted access to the system by Administrators. The application process begins when the user selects the Create Submission or Create Renewal option in the menu at element 113.

In a first step in the user application creation and submission process, a user is presented with the Client Search page element 114 containing a list of all the clients associated with the User's company. Additionally, and as discussed earlier, the user has the option to Create a New Client or enter part of the client name to perform a search for the client and select them from a presented list. the user can Cancel the process and return to the Messages page although this is not completely shown as it was discussed earlier.

If the client already exists, a list of possible matches is displayed and the User can select the client to go to the next step. If the User selects the New Client option, the User is presented with the Preliminary Client Data page requiring data including the client's name and phone number. Validation is performed on the entered data and if fails, appropriate error messages are displayed.

If the validation steps pass, the system checks the client database for any matching entries with current submissions submitted by other Users. If a match is found, a message page is displayed requiring the User to contact the MGA for further instructions. If the client is not found in the system, the User is presented with the next step. The User can Cancel the process and return to the Messages page. Validation is performed on all entered data and if the process fails, appropriate error messages are displayed. If validation passes, a new client record is created for the company and the User is presented with the next step.

In a second step in the user application creation and submission process, the user is presented with the Start Client App—Select Coverage Types page at element 128 requesting the effective date, expiration date, primary state, coverage types and other data identifying the insurance being applied for and the preferred method of communication (options are Email Notifications and Fax).

Note: those skilled in the art should recognize that the user may optionally submit multiple coverage types for processing with the same submission. The User can Cancel the process and return to the Messages page. Validation is performed on entered data and if fails, appropriate error messages are displayed. If validation passes, the system creates a new submission record in the database, assigns a status of Not Yet Started to the submission and presents the User with the next step.

In a third step in the user application creation and submission process, a user is presented with the Select Forms page at element 130, which displays a list of forms available for data entry directly into the system.

The User can change the coverage types by selecting the Change Coverage Types link. If selected the User is displayed an Update Coverage Types where they are presented with the same options as those detailed in the second step above. Upon update, the submission record is updated in the database and the User is returned to the Select Forms page. The User can Cancel the process and return to the Messages page.]

It is noted that, for one skilled in the art it is recognized that if the User cancels the process at this point the status of the submission remains identified as “Incomplete” and a “form level status” identifier is displayed next to each form option to advise the User and MGA of the status of the completion of the respective form. In a Renewal Application, all forms are identified as Incomplete until the last step.

Here, the User selects a Enter Data button (not shown) to create a new form record (see Description of Forms below). When the Select Forms page is displayed, the system checks the status of each form. The User can Remove the submission at any time prior to submitting to the MGA. Client information can never be removed from the database except by an MGA administrator thereby preventing inappropriate loss and enabling users to never loose data for improved user convenience.

If any of the form level statuses are “Incomplete,” the Remove button allows the User to Archive the submission form data so that it can be used again later if needed as a form of “draft application”. As an additional security measure to prevent incomplete submissions, a “Submit” button only displays if all of the form level statuses are set to Complete. When selected, the User is presented the Submit to MGA step noted in step four below.

As noted above, the below section describes “Forms” matters and selected “Dialog Window” matters in a manner sufficient to enable those skilled in the arts of electronic systems design for insurance systems to encompass the present invention.

Description of Forms

Users select an “Enter Data” action for the appropriate form displayed on the Select Forms page detailed in 3 above. (See elements 130 to 132) Upon display of the HTML based forms, any information already gathered about the client will be pre-filled in the appropriate form fields. The system creates a new form specific record in the database and assigns an Incomplete status to the form. All the data entry forms contain fields laid-out in insurance industry standard format designed for ease of use for the User familiar with completing paper-based forms. The User can Cancel the data entry and is returned to the Select Forms page. By doing so, the forms status remains as “Incomplete” as a status identifier.

With “incomplete” forms, the User can save the entered data at any time by selecting the Save For Later button. The form record is updated in the database with all entered data, the form status remains as Incomplete, and the User is directed back to the Select Forms page. For sections that allow multiple record items (for example locations, individuals, or hazards), the system allows the User to “Add” unlimited numbers of items.

All items added to the electronic form allow the User to “Update” or “Remove” the item. A dialog window containing the appropriate fields is displayed when the Add, Update or Remove options are selected (see description of Dialog Window below). Upon completion of the form, the User can select a “Finished” button (not shown) to proceed. Complete field validation is performed and appropriate error messages are displayed if validation fails. Additionally, if validation fails, fields containing missing or incorrect data are highlighted so the User can locate them easily. Upon successful validation, the form record is updated in the database with all entered data, the form status is changed to “Complete”, and the User is directed to the Select Forms page.

Dialog Window

As used throughout invention discussed herein, a “dialog window” is launched in cases where there are multiple record items on a form. An “Add” dialog window contains all appropriate fields to the section it was launched from. The user can select Cancel and in doing so, will close the dialog window. When the dialog window closes, the data entered in the form where the dialog window was launched from is saved to the database and the page is refreshed. The User can select Add Another button (not present on Update or Remove) whereby the dialog window remains open, and validation is performed on all entered data. If validation fails, appropriate error messages are displayed. If validation passes, the data entered is created as a new data record in the database and the fields are reset.

Finally, the User can select “Finished” if the user is done with adding, updating, or removing an item. Validation is performed on all entered data. If validation fails, an appropriate error messages are displayed. If validation passes, the action is taken with adding, updating or removal of the records from the managing database and the dialog window is closed. The data entered in the form where the dialog window was launched is saved and any additions, updates or removals of data in the dialog window are displayed on the form.

In a fourth step in the user application creation and submission process, users are presented with the Submit to MGA page (element 133) whereby the User can view the submission in Adobe .PDF format and then must enter their initials to acknowledge that they have reviewed or “certified” the forms being submitted. This aspect of the present system is yet another step in improving the speed and smoothness of effective business operations and the rapid grant of valid insurance issuances.

The user can also enter specific processing instructions for the Underwriter to aid the underwriting process. If the User is familiar with dealing with a specific Underwriter, they have an option of selecting the Underwriter that they wish to have process the submission from a list of Underwriters. The list of Underwriters is determined by the selected branch of the MGA identified during step five of the above-described registration process.

If there is no particular Underwriter selected, the system will automatically assign the submission to the Underwriter with the least amount of open submissions. The user selects the Submit button (element 134) to submit the entire submission to the MGA for processing. Instructional text is saved as a new instruction record in the database and the submission status is changed to Submitted. The selected Underwriter (if selected) is assigned to the submission. The User is presented with a Confirmation page for record confirmation and validity. This another important aspect of the present invention that speeds business.

Endorsement Request Submission Process

As discussed herein, the submission process contains three core steps to complete an “Endorsement Request” and submit the complete package to the MGA for processing. To improve operational security and minimize errors, access to the request process is restricted to “Administrators” and those Users that have been granted access to the system by Administrators. The application process begins when the User selects a “Create Endorsement” (not shown) option in the menu and follows the below steps 1 through 3.
Step 1. User is presented with the Client Search page containing a list of all the clients associated with the User's company with completed Policies. The user has the option to enter part of the client name or Policy Number to perform a search for the client. The user can Cancel the process and return to the Messages page. If the policy is found, the client is selected and the User goes to the next step.
Step 2. User is presented with the Endorsement Application page displaying detailed policy information. A new Endorsement Request record is created in the database with a status of Incomplete. The user can Remove the request, Save for Later, or once completed, submit to the MGA for processing. All information is updateable, or removable. New additions can also be added to the policy. All information is saved to the database. However, as an additional security measure none of the original submission data is updated until the Underwriter reviews and accepts the Request detailed below in the Endorsement Processing Section.
Step 3. Upon completion of 2 above, Users are presented with the Submit to MGA page whereby the User can view the submission in Adobe PDF format or other suitable format and then must enter their initials or other identifier to acknowledge that they have reviewed the request being submitted. The user can also enter processing instructions for the Underwriter. If the User is familiar with dealing with a specific Underwriter, they can select the Underwriter that they wish to have process the submission from a list of Underwriters. The list of Underwriters is determined by the selected branch of the MGA identified during step five (noted above) of the registration process. If there is no particular Underwriter selected, the system will automatically assign the request to the Underwriter that originally processed the Policy. The User selects the Submit button to submit the request to the MGA for processing. Instructional text is saved as a new instruction record in the database and the request status is changed to Submitted. The selected Underwriter is assigned to the request. The User is presented with a Confirmation page.

Current Submissions

As discussed herein, the “Current Submissions” section of the present system provides a snapshot of the statuses of all the submissions submitted to the MGA for processing, including Endorsement Requests and Renewal Submissions. This aspect of the present invention only displays submissions related to Users who are associated with the company, and is divided into seven (7) core sections each noted below.

1. Incomplete Applications/Not Yet Reviewed: This first section lists all submissions that have been started but have not been completed. For those submissions identified as Incomplete or Not Yet Started, the User can Update the submission's application forms and submit it to the MGA as described in E above or remove the application from the system. For submissions that are identified as Not Yet Reviewed, the User can View the submission but not make updates to it.

2. Updates Required: This second section lists all submissions that have been reviewed by the Underwriter at the MGA and sent back to the User for updates. There are two types of update requests; Critical and General. Critical requests indicate that the application cannot be processed without the required information. General requests indicate that the application can continue to be processed. If rating functions have not yet been performed by the Underwriter at the MGA, the User can submit updates to the submission as described in section E above, otherwise, updates will be sent by way of an entry box so that the submission can be updated by the Underwriter. When submitted for processing, the submission status is changed to Re-Submitted. An Adobe .PDF version of each iteration of the application is saved on the server.

3. In Process: This third section displays all submissions that are in process by the MGA. A real-time status is displayed showing where the submission is in the process. The user can view the submissions or, if the submissions status is Updates Needed, the User can update the submission as described in 2 above.

4. Quotes Ready: This fourth section displays all submissions where a Quote has been created by the Underwriter and sent to the User for review. The User can view the quote(s), accept, decline or request a re-quote. If the User accepts the quote, the submission status is changed to Accepted Quote and the Underwriter will begin the Binding process. If the quote is declined, and no other quotes are in the system, the quote and application data is archived and the status is changed to Archived. If there are other quotes in the system, they remain active for a pre-determined period of time after-which, are archived. If a re-quote is requested, the User is presented with an Instructions page where they advise the Underwriter what needs to be changed. In this case, the submission status is changed to Re-Quote Requested. Note: All quotes presented to the User are archived in Adobe .PDF format.

5. Binder Ready: This fifth section displays all submissions where a Binder has been created by the Underwriter and sent to the User. The User can view and print the Binder as necessary. The submission only stays in this section until the Policy is issued.

6. Policy Ready: This sixth section displays all submissions where the Policy has been issued and has been reviewed by the Underwriter and sent to the User. The User can view the Adobe PDF version (or other suitable format) of the submission, the Quote, the Binder and the Policy as needed. The user can also see items that the underwriter requested which have not been satisfied or request an Endorsement. The submission only remains in this section for a pre-determined period of time after-which the submission and all documents are sent to archive.

7. Declined: This seventh section displays all submissions that have been declined by the Underwriter at the MGA. The User can view the reasoning behind the decision to decline. The submission only remains in this section for a pre-determined period of time after-which the submission and all documents are sent to archive.

Client Management

As considered by the present invention, the Client Management feature and aspect of the present system enables the user to search for a client and view detailed information about the client. Information viewable to the User is as follows for ease of process flow, to answer any questions, and to readily confirm accuracy in a way to achieve one of the needs discussed above. With the client management feature, there are four aspects or options, as noted below:
1. Details—this tab shows details such as Insured Name, address, etc., which can be updated by the user. Also premises and loss information is available.
2. Policies—the tab displays any current and past Policies issued to the Client including Endorsements. Endorsement Requests and Renewals Submissions can be initiated.
3. Documents—this tab lists all documents for each submission such as Application(s), Quote, Binder, and any attachments made to the submission. The user can also upload documents to a submission.
4. Contact Log—all correspondence between the User and the Client can be entered and viewed.

Profile/Settings

As considered by the present invention, the Profile/Setting feature of the present invention enables a user to readily (from within the system) update their personal information, email address, password, and user id. If the User is designated as an Administrator, the User can update the company information, user access functions and re-assign their administrator rights. Such electronic capacities greatly speed data entry, system management from all aspects, and improve overall use-ability as benefits of the present invention.

Contact MGA

As considered by the present invention, the “Contact MGA” or simply “Contact” feature provides important contact information about the MGA to answer any questions and continually aid the inventions efforts to speed operation and hence increase management and data entry efficiency by minimizing errors.

The user can search for an employee at the MGA and, if found, will be provided with a link to a communications page as well as the phone number and contact information to the Underwriter's or other title. The communications/contact page and option allows the user to send a message via email to the Underwriter. When the message is sent, all information is stored in the database. As an additional feature, a “suggestion box” for MGA management feedback is available on the system and the ability for the User to submit Technical Support issues is also available.

Underwriter System Description

As noted herein below, a step-by-step description is provided of the general operational aspects of the Underwriter System as provided by the present invention.

A. Underwriter Sign-In:

In a manner similar to that described above a User ID and Password are required to gain access to the system from the Underwriter side. An administrator creates the Underwriter record in the Administration Tool described below. The Sign-In page requires that the Underwriter provide their unique User ID and Password. The system verifies entered data with data stored in the database. The Underwriter is permitted three failed attempts at sign-in after which, the Underwriter is directed to contact technical support. Upon successful authentication, the Underwriter is presented with the Messages page. The system automatically detects Assistant status of the authenticated user.

B. Underwriter Message Center:

This inventive feature displays any Underwriter specific messages created in the Administration Tool as discussed below. If the Underwriter is identified as an “Assistant”, see Assistant description below. At the top of every page, the counts of the number of applications assigned to the Underwriter in each “work queue” are displayed based on a real-time application status. Work queues are identified as follows:

1. Submissions: This queue displays a list of submissions (New or Renewal Submissions) that have either been started by the Underwriter or an Underwriter Assistant or submitted or resubmitted for processing and assigned to that Underwriter by a User. Additionally, any incomplete Endorsement Requests started by the Underwriter or Assistant will display here. The list shows a real-time status of where the submission is in the process. The underwriter has the option to select the submission and begin processing.
2. Need to Bind: This queue displays a list of all submissions for which the User has accepted a Quote and requested that the Underwriter create a Binder. The Underwriter can select the submission and begin the Binding process.
3. Action Required: This queue displays a list of all submissions that require an action. It serves as a catch all for those submissions that during the process are in need of attention. The Underwriter can select the submission and continue processing.
4. In Process: This queue displays a list of all the submissions that the Underwriter is waiting for an action from another party, such as critical information is requested, the quote has been sent to the User, waiting for a quote from the rating department or Carrier, etc. The Underwriter can view the submission, or request a follow-up.
5. Follow-up: This queue displays a list of all submissions that a request for information was sent and is past due. Underwriters can request a follow-up or remove the request for information.

As an aside noted above, any designated “Assistant” is required to assign them selves to a specific Underwriter by selecting the appropriate Underwriter from a drop down box when first accessing the Messages page. This allows Assistants to work any Underwriter's queues and be tracked accordingly. The Assistant can change their assignment to any other Underwriter at any time by accessing the Messages page. When the Assistant logs off of the system, they remain assigned to the selected Underwriter until changed the next time they sign-in. The Assistant is not able to perform any functions within the system until they have assigned themselves to an Underwriter.

C. Create Application Section

This improved feature allows the Underwriter (or the Assistant) to create New Submissions, Renewal Submissions, Endorsement Requests or Cancellation Requests on behalf of Brokers (not enrolled in the system) for those items received at the MGA by email, fax or postal service. The process for creating the submission is the same as that described in Broker Section noted above. A newly created submission is assigned to the Underwriter at time of creation. Communication settings are selected for the submission (options are Email with Attachments and Fax). The system determines if the submission is being created for a User that is already enrolled in the system. If enrolled, communication options are Email Notification and Fax.

Within the Underwriting System, a particular aspect of the present invention is the Submission Management Process, as will be discussed.

D. Submission Management Process for Underwriting

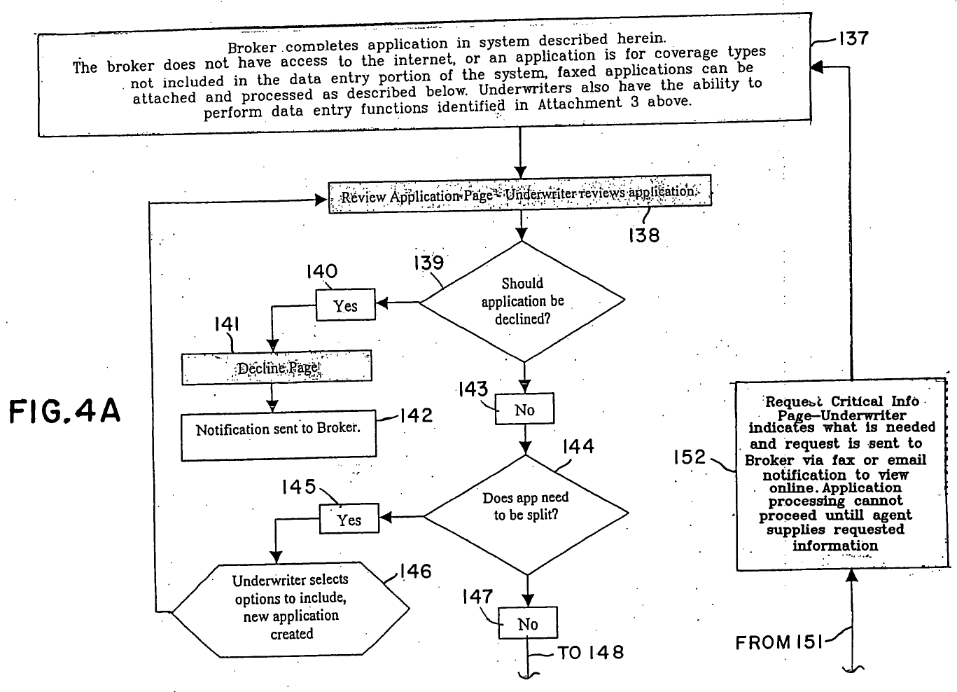

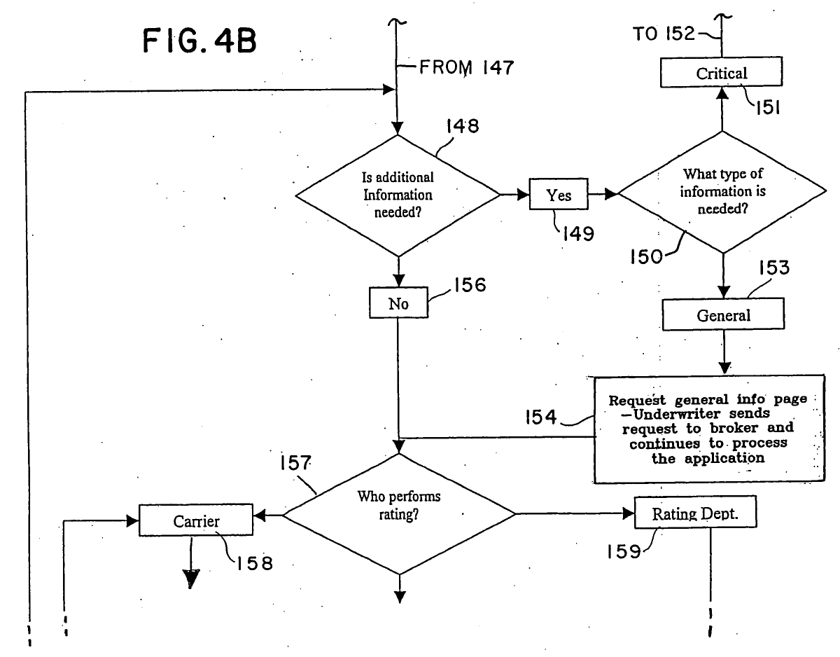

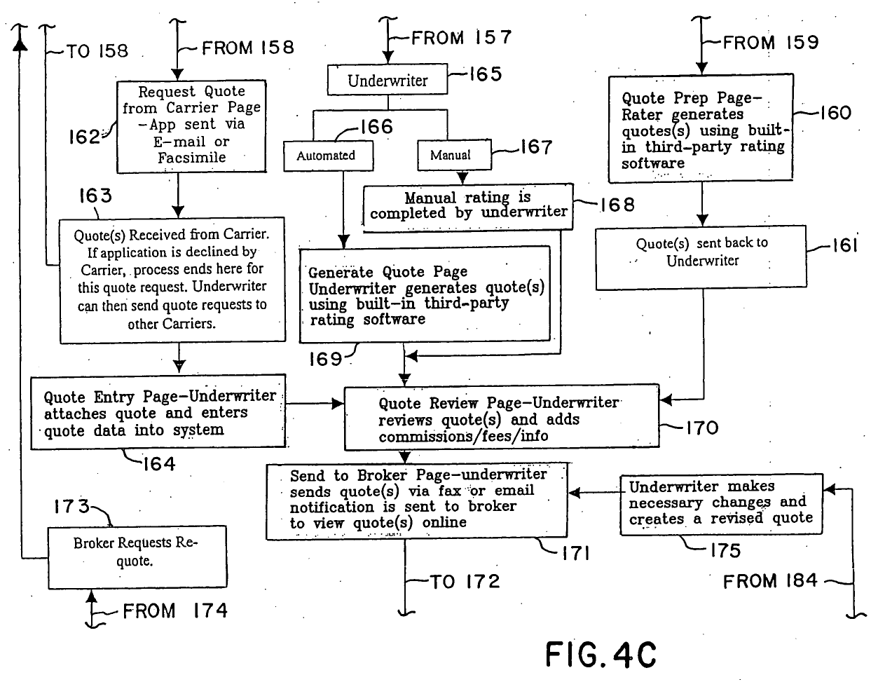

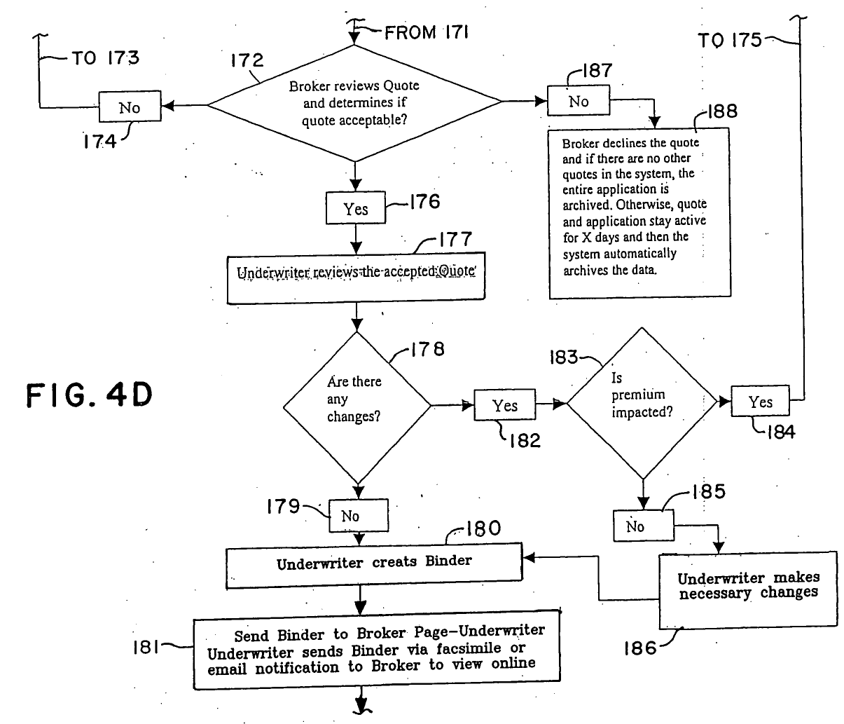

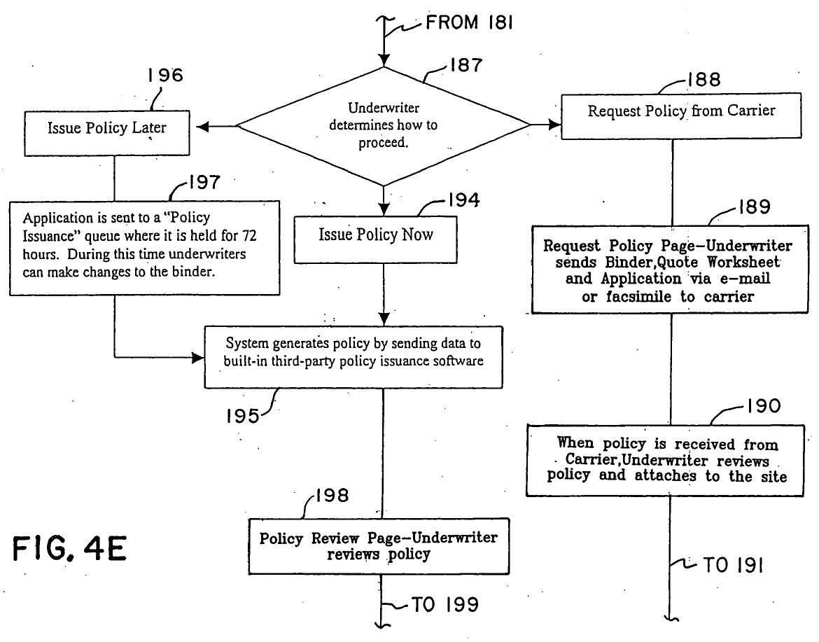

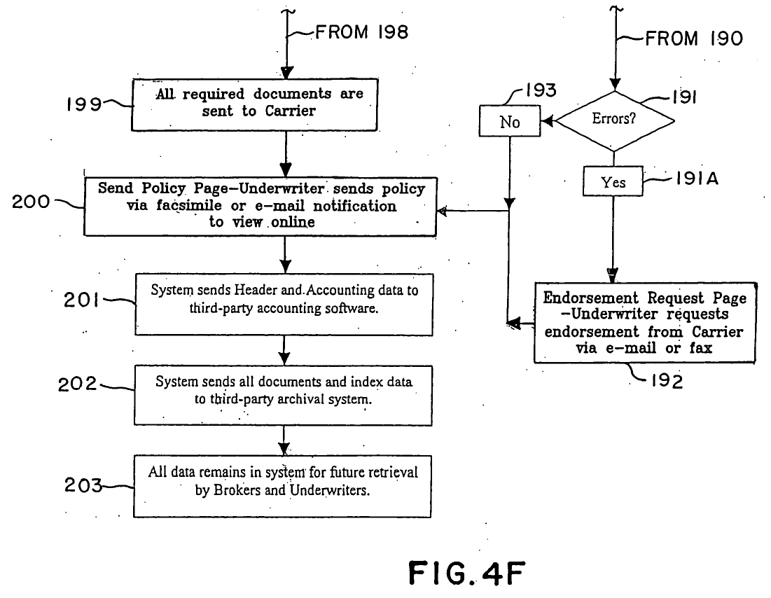

Referring now to FIGS. 4A through FIG. 4C, and elements 137 through 203, the following is a detailed description of the process flow for underwriting functions pertaining to the received submission at the MGA.

Those skilled in the art should understand that throughout the process disclosed, “system generated notes” are created detailing the date and time each task was completed, who performed the task and what was performed, thereby allowing ready management and tracking and backtracking for training. Additionally, on every selected application page, the Underwriter is presented with an “Information Panel” detailing the Client's Name, the Broker's Name and phone number, the Coverage Types, Proposed Effective and Expiration dates, a real-time status, and all supporting documents created during the process (such as Applications, Supplemental Applications, Quotes, Binder, etc.). As a consequence, the inventive disclosures provided herein are substantial and respond to many of the needs noted above for accuracy, efficiency, tracking, training, and improved economy and information process flow.

A general process flow commenting on element steps 137 through 203 is provided below.

In a first step, an application for insurance is completed by a user on behalf of a client as described previously in the Broker Section above. The submission's status is set to “New Submission” and can be found in the Submissions queue for the underwrite to select or to be assigned thereto.

If the Underwriter at the MGA receives the submission via fax, email or postal mail, the Underwriter or Assistant can upload the submission documents to the server and enter the data as described in Section C above. During this process, the submission's status is set to “Incomplete” throughout the process until the application forms have been completed, after which the submission's status is set logically to “Submitted” and can be found in the Submissions queue for selection or assignment. An Adobe PDF or other electronic format version of the submission is saved to a server as a back-up and to support the ongoing process.

In a second step, the Underwriter “Reviews” the submission and has the following options presented for selection:
a. Decline—the submission status is changed to Declined and a notification is sent to the User/Broker via email or fax. All documentation and data is archived after a pre-determined period of time.
b. Re-Assign—the Underwriter can re-assign the application to another underwriter for processing.
c. Split—the Underwriter can split the original submission by LOB (location of business) and/or other action thereby creating new submissions to process.
d. Request Critical Info—The Underwriter may optionally send a notification to the User/Broker via the selected method of communication requesting information. The application status is changed to Need Critical Info and moved to the In Process queue. The Underwriter cannot proceed until the User updates the application and re-submits to the MGA. See Broker Section above.
e. Request General Info—The Underwriter sends a notification to the User/Broker via the selected method of communication requesting the information. The submission status remains as “Action Required” to continue processing.
f. Save for Later—The submission remains in the “Action Required” queue with a “Ready for Rating” status.
g. Rating Options—The underwriter determines how the submission will be rated according to a predetermined rating system.

In a third step, and pursuant to option g “Rating Options” above, the Underwriter selects from the following rating options:
a. Send to Carrier—The Underwriter sends a request to the Carrier via email or fax to rate the submission. Accompanying the request is the application information. The submission status is changed to “Need Quote From Carrier” and a follow-up record is created. When quotes are returned from the Carrier, the Underwriter can upload the quotes to the server and enter the quote data into the system. Submission status is changed to “Action Required—Ready to Send Quotes.” If the Carrier declines the request, the Underwriter will remove the request from the system. Quotes can be requested from multiple Carriers to speed the process and achieve a suitable rate.
b. Send to Rating Department—The Underwriter sends a request to the MGA Rating Department to rate the submission. The submission status is changed to “Need Quote—Rater”. Subsequently, the Rating Department performs the rating functions using integrated software provided by designated software solutions providers or external rating systems. After rating is complete, the Rating Department sends the quotes back to the Underwriter and the submission status is changed to “Action Required—Ready to Send Quotes.”
c. Generate New Quote—The Underwriter completes a Quote form pre-filled with data from the application and generates quotes using integrated software provided by designated software solutions providers. Submission status is changed to “Other Action Required—Ready to Send Quotes.” Multiple quotes can be therefore quickly and accurately generated with complete information.
d. Manually Rate—The Underwriter is rating the policy “outside of the system” whether by using documentation from a Carrier or by using a Carrier's website in a customized manner.

In a fourth step, pursuant to the above, if the Underwriter sends the quote(s) to the User/Broker, a custom quote form is generated containing information from the application and the quote worksheet. The Underwriter must then select appropriate Exclusions that will apply to the quote, some of which are pre-selected based on Quoting Carrier, State, and LOB. This is sent to the User/Broker via the selected method of communication. Submission status is changed to “In Process—Quotes Sent to Broker”. An Adobe PDF or other suitable electronic format copy of each quote is saved to the server as an archive.

Those of skill in the art of systems and software design should note that all supplemental applications are stored on the system and are dynamically displayed to the User/Broker to print, complete and fax to the Underwriter as necessary. The underwriter then has the option to send the quote to the User/Broker, Change the Quote or Generate a New Quote, etc.

In a fifth step, pursuant to the first step in the Submission Management Process for Underwriting as noted above, the User/Broker reviews the quote(s) and determines how to proceed along the following guidelines:
a. If quote is accepted, the User notifies the Underwriter via the system detailed in Broker Section G4 above or by fax. If done via the system, the submission status is changed to Accepted Quote and is moved to the Need to Bind queue. If by fax, the Underwriter can locate the submission in the In Process queue and has the ability to begin the Binding process by selecting the appropriate quote and uploading any supporting documentation.
b. If quote is unacceptable, the User/Broker can request a re-quote via the system or by fax. The application status is changed to Action Required—Re-quote Requested.
c. If the quote is declined by the User/Broker, and no other quotes or quote requests are present, the system will archive all data and documents. If there are other quotes in the system, they remain active for a pre-determined period of time after-which, are archived.
d. If no action is taken by the User/Broker, the quote remains valid for a pre-determined period of time, after-which the quote, all data, and documents are archived.

In a sixth step, pursuant to the second step (item b “Re-Assign) in the Submission Management Process for Underwriting as noted above, the Underwriter performs rating functions described in the third step above.

In a seventh step, pursuant to the second step in the Submission Management Process for Underwriting as noted above, the Underwriter begins the Binding or Review process. The Underwriter creates a Binder based on the information from the quote. If the User/Broker indicates additions needed to the policy, the underwriter determines how to proceed:
a. Premium Impacted: If the changes impact the premium, the Underwriter makes the changes and sends a Request for Acceptance to the Broker via the selected method of communication. The submission status is changed to “In Process—Quotes Sent to Broker.” The User/Broker reviews the quote as described above.
b. Non-Premium Impacted: If the changes do not affect the premium, the Underwriter makes the changes, selects the appropriate policy forms to appear on the Binder and to be included in the completed Policy and continues the process.

In an eighth step, pursuant to the fourth step in the Submission Management Process for Underwriting as noted above, the Underwriter indicates whether all supplemental forms have been received from the Broker. Those of skill in the art will note, that any supporting documentation received via fax or email can be uploaded to the server from within the Client Servicing section described below or on any submission specific page from within the Information Panel described above. If documents are still needed, the follow-up request will remain in the Follow-up queue. Thereafter, the “Binder” is sent to the User/Broker via the selected method of communication. The submission status is changed to “Action Required—Binder Sent” and an Adobe PDF or other electronic format copy of the Binder is saved to the server as an archive.

In a ninth step, pursuant to the fifth step in the Submission Management Process for Underwriting as noted above, the Underwriter determines how to proceed according to the following options:
a. Request Policy from Carrier: The Underwriter sends a request to the Carrier via email or fax to Process the Policy. All documentation to accompany the request is selected by the Underwriter. The submission status is changed to “In Process—Need Policy from Carrier” and a follow-up request is created. When the Policy is received from the Carrier, the Underwriter can upload the Policy to the server. The submission status is changed to “Action Required—Ready to Send Policy.”
b. Issue Policy Now: The Binder information is communicated to integrated software provided by a designated software solutions provider. The submission status is changed to “Action Required—Ready to Send Policy” and the Underwriter is presented with the Policy Review page. Electronic format (Adobe PDF) copies of the Insured's Policy, Broker's Policy, MGA Policy, and Carrier Policy are saved to a server archive system.
c. Issue with Delay—The submission status is changed to “In Process—Policy Issuance Department.” A follow-up request is created for the Policy Issuance Department. If a change is requested prior to the Policy documents being created, the Underwriter can recreate the Binder as detailed above. If no changes are received prior to a predetermined period of time, the Policy Issuance Department will create the Policy documents as detailed above.

In a tenth step, pursuant to the Submission Management Process for Underwriting as noted above, the Underwriter sends the Policy to the User/Broker via the selected method of communication. The submission status is changed to “Action Required—Policy Sent.”

In an eleventh step, pursuant to the Submission Management Process for Underwriting as noted above, the Underwriter sends all appropriate documentation the Carrier via email, fax, or other suitable means.

In a twelfth step, according to the Submission Management Process for Underwriting above in step eight, the Underwriter determines if an Inspection request is needed to confirm all firms were transmitted fully. If yes, the Underwriter completes an Inspection Request form and sends the request via fax or the system communicates directly via the web with Inspection Services Providers. A follow-up request is created. When the inspection request is returned, the follow-up request can be found in the Follow-up queue where the inspection can be uploaded to the server and sent to Carrier.

In a thirteenth step, according to the Submission Management Process for Underwriting above in the ninth step, the Client Header and Policy information (and any other appropriate information items) are sent to internal MGA accounting software provided by a designated software solutions provider for Billing and Accounting purposes and for the tracking of the same.

In a fourteenth step, according to the Submission Management Process for Underwriting above in the tenth step, the system sends all documentation on the server to internal MGA software provided by a designated software solutions provider for document Archival purposes as a future reference.

The present invention also includes additional features, noted below, that are not illustrated in FIGS. 4A through FIG. 4B. These features include a “Quick Find”, a “Quick Quote”, “Others Users Queues”, “Reports”, and “Setting” features.

In the Quick Find feature, the system provides the Underwriter with the ability to search for a client based off of Client Name or Phone Number. When a client is found and selected, the Underwriter is presented with four tabs as follows:
a. Details—Displays current details about the client including name, address, premises information and loss history. The Underwriter has the ability to update the Inspection/Accounting contact information.
b. Policies—Displays current and past Policy documents and Endorsements, viewable in Adobe .PDF format.
c. Documents—The Underwriter can view all pertinent documents associated with the client and also has the ability to upload documents.
d. Notes—Displays all notes associated with each submission. The Underwriter also has the ability to add a note.

In the Quick Quotes feature, the system allows the Underwriter to perform rating functions without having to complete an application. Rating is consequently performed using integrated software provided by designated software solutions providers. Rating data is stored only for reporting purposes.

In the Other Users Queues feature, the system provides the ability for an Underwriter to process applications that are assigned to another Underwriter who is flagged as being Out Of Office (for example out sick, traveling, vacation, maternity leave, etc.). See the “Settings” discussion below.

In the “Reports” feature, the system contains and can be requested to generate various production reports specific to the Underwriter and the work requested in a manner known to those of skill in the art.

In a “Settings” feature, the present system provides three report sections:
1. Out Of Office—This feature allows the Underwriter to set them selves as Out Of Office so that other Underwriters can work their work queues.
2. Signature—This feature allows the Underwriter to upload an image of their signature to the server to appear on appropriate documents.
3. Change Password—This feature allows the Underwriter to update their password.

Before moving further in the discussion it is essential to those of skill in the art to recognize that the present system, described above in “D. Submission Management Process for Underwriting” provides many unique inventions. These include the automated generation of tracking notes throughout the underwriting process, the transmission of a Binder to the insured even if there are ultimate delays in issuance, the capture of notes and information on the background provided by an underwriter that may be used to confirm information or allow another underwriter to take over the matter, the generation of both automated and manual rating systems allowing application to quotes across a wide variety of circumstances and types of insurance products, and much more.

The present invention also enables, via elements 187-198, the use of quality control features to capture errors, within a commonly designated error time frame. For example, a policy may be issued directly or delayed for later issuance allowing a temporary hold to be placed on the issuance to correct underlying errors or incorporate known changeable information (addresses, etc.). Thus the present system minimizes costs, by eliminating the need to “re-issue” issued policies by allowing time to incorporate change safely without loss of data. This system also allows managers to identify and check notes of common errors and build in additional quality control checks or flag selected items or underwriters, etc. for quality control and to run management reports.

Endorsement Request Processing System

As noted herein below, a step-by-step description is provided of the general operational aspects of the Endorsement Requesting Processing System provided by the present invention.

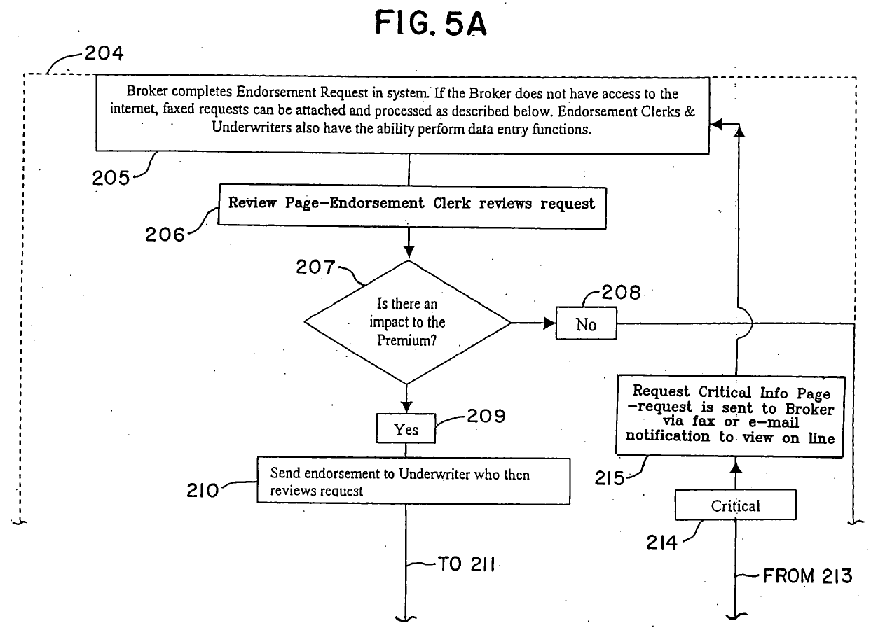

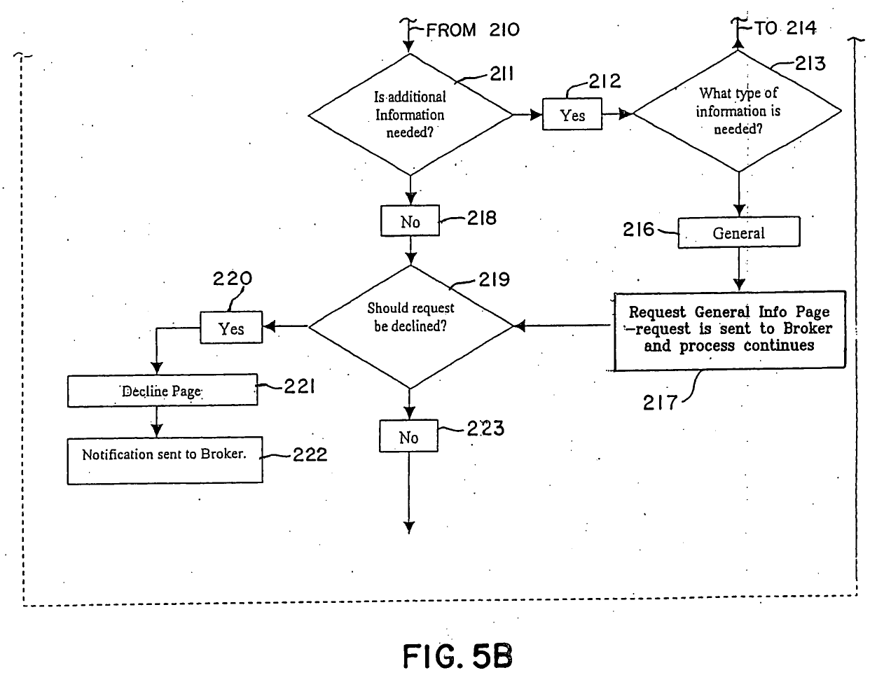

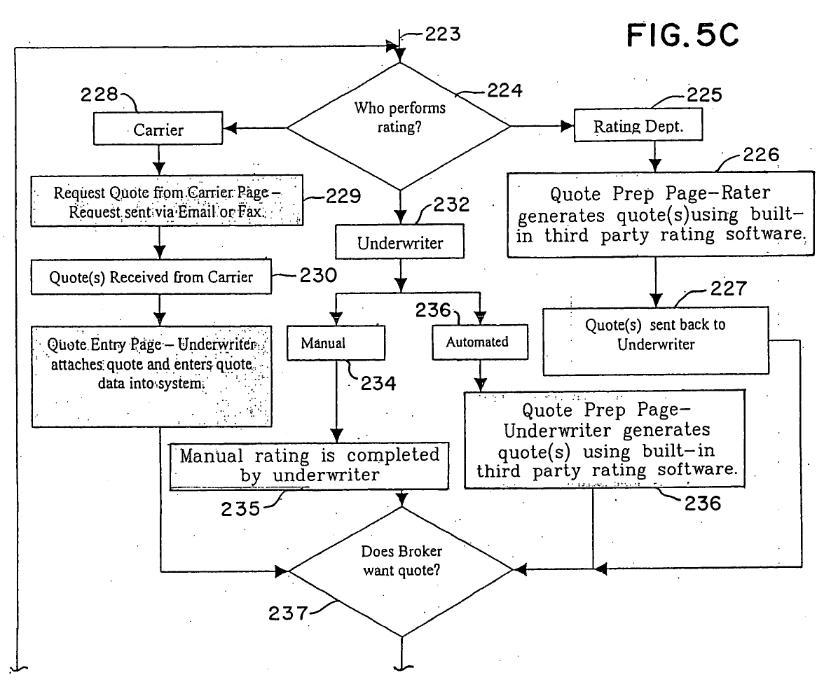

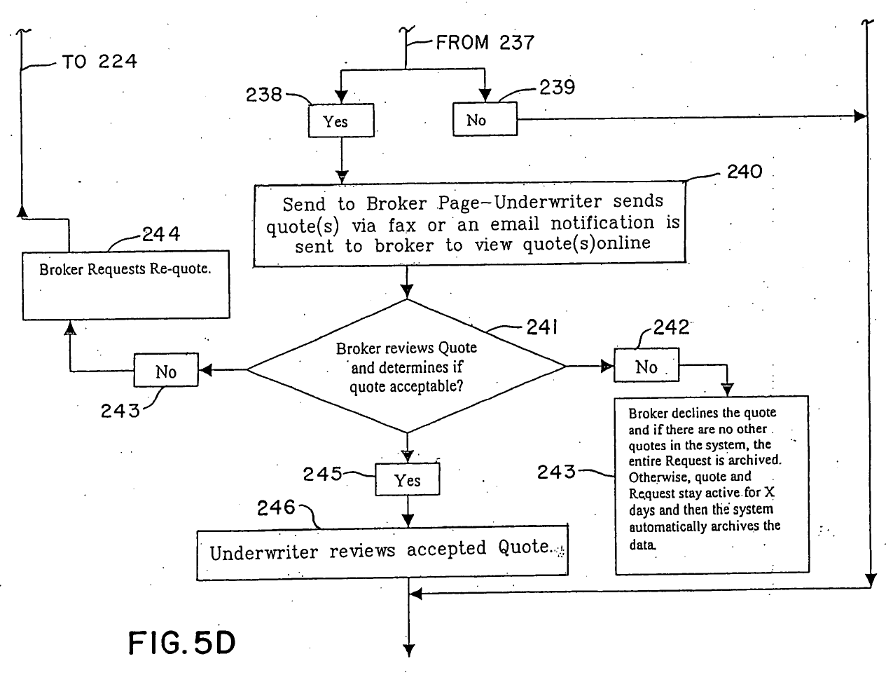

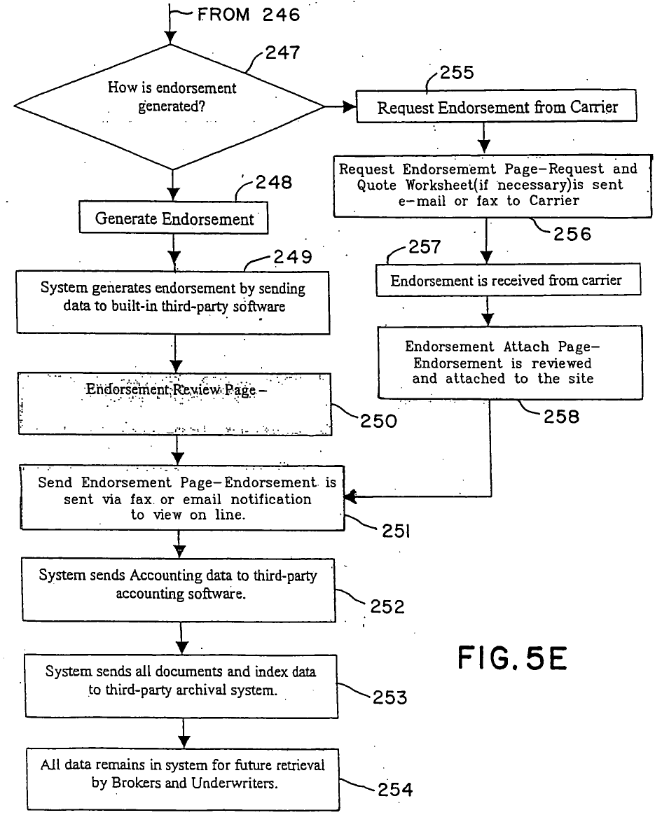

Referring now to FIGS. 5A through 5C and elements 204 through 254, the following is a detailed description of the process flow for Underwriting functions pertaining to a received endorsement request at the MGA.

Those skilled in the arts of insurance management should recognize that throughout the process, system generated “electronic notes” are created detailing the date and time each task was completed, who performed the task and what was performed, as well as any additional follow-up matters. This electronic note feature aids substantially to the speed and continuity of each application/endorsement request.

Additionally, it should be understood that on every selected endorsement request page, the Underwriter is presented with a “control panel” detailing the client's name, the Broker's name and phone number, the Coverage Types, proposed effective and expiration dates, Endorsement Request status, and all supporting documents created during the process.

Underwriter System Process

The underwriter system process is described below and generally follows ten optional steps (discussed below). As should be noted by those of skill in the art, selected steps may be chosen or used optionally depending upon the circumstances and the preceding step in the process.

1. In a first step, when an “Endorsement Request” is submitted by a User as detailed in the Broker Section description above, the request is received and viewed by an Endorsement Processor (typically a skilled clerk) in the Endorsement Processing System as will be detailed more fully below, and as initially described at element 204. As noted in element 205, if the Endorsement Request is submitted via email, fax or postal mail, the request can be created by either the Clerk or an Underwriter. If the Clerk determines the request to be too complicated for simple processing or other for other reasons, the Clerk will send the request to the Underwriter for further processing, see element 210. The request can thereafter be found in the Underwriter's Submissions queue with a status of “Submitted” and is available for further access and processing.

2. In a second step, the Underwriter reviews the request and determines if any additional information is needed. The Underwriter then determines if the information needed is “critical” to the process or only “general” as discussed below.

a. Critical: When the information needed is critical (element 214), the underwriter sends a notification to the User/Broker via the selected method of communication requesting information. The request status is changed to “Need Critical Info” and moved to the In Process queue. The Underwriter cannot proceed until the User/Broker updates the request and re-submits to the MGA.
b. General: When the information needed is only general (element 216), the underwriter sends a notification to the User/Broker via the selected method of communication requesting the information. The request status remains in “Other Action Required” to continue processing.
   3. In a third step, the underwriter reviews the request and has the ability to decline the request if not able to proceed (element 219). In this case, the request status is changed to “Declined” and a notification is sent to the Broker via the selected method of communication. All documentation and data is archived after a pre-determined period of time. Additionally, the Underwriter can Re-Assign the request to another Underwriter to continue processing. If the re-assignment is accepted, the Underwriter can continue processing.
   4. In a fourth step, pursuant to the third step above, if a quote was requested by the User/Broker or an adjustment to premium is caused by the request, “rating functions” are performed as follows:
a. “Send to Carrier”—The Underwriter sends a request to the Carrier via email or fax to rate the request. Accompanying the request is the application information. The request status is changed to “In Process—Need Quote From Carrier” and a follow-up record is created. When quotes are returned from the Carrier, the Underwriter can upload the quote to the server and enter the quote data into the system. Request status is changed to “Action Required—Ready to Send Quote.” If the Carrier declines the request, the Underwriter will remove the request from the system.
b. “Send to Rating Department”—The Underwriter sends a request to the MGA Rating Department to rate the request. The request status is changed to “Need Quote—Rater.” Subsequently, the Rating Department performs the rating functions using integrated software provided by designated software solutions providers or external rating systems. After rating is complete, the Rating Department sends the quote back to the Underwriter and the request status is changed to “Action Required—Ready to Send Quote.”
c. “Generate New Quote”—The Underwriter completes a Quote form pre-filled with data from the request and policy and generates the quote using integrated software provided by designated software solutions providers. Request status is changed to “Other Action Required—Ready to Send Quote.”
d. “Manually Rate”—In this function, the underwriter is rating the policy “outside of the system” whether by using documentation from a Carrier or by using a Carrier's website or in some other suitable manner. Having this type of manually rate function within the present system allows the system to absorb and handle unusual situations outside the normal bounds. As these circumstances normally take an inordinate amount of resources and energy on a per-quote basis. As a result, one benefit of the present system allows crafting an electronic process that easily handles this type of transaction. Thus, the present invention provides a strong business advantage to the MGA.
   5. In a fifth step, further to the fourth step above, the Underwriter sends the quote to the Broker via the selected method of communication. Request status is changed to “In Process—Quote sent to Broker” to continue the practice discussed herein of a streamlined management process readily tracked at each stage. Obviously, an Adobe PDF or other electronic type of copy of the quote is stored on the server for later access.
   6. In a sixth step, further to the fifth step above, the User/Broker reviews the quote and determines how to proceed using the following parameters:
a. If quote is accepted, the User notifies the Underwriter via the system detailed in the Broker section above or by fax or other suitable means. If notification is done via the electronic system, the request status is changed to “Accepted Quote” and is moved to the “Create Endorsement” queue. If by fax, the Underwriter can locate the submission in the In Process queue and has the ability to begin the Endorsement Creation process by selecting the appropriate quote and uploading any supporting documentation.
b. If quote is declined by the User/Broker, the system will archive all data and documents. This provides a principal benefit of the system, whereby with time a strong library of declined quotes is stored allowing for management study and learning to improve and change the process to minimize declined quotes. Thus, this storage mechanism provides a substantive benefit to the user even if no quote-business is generated.
c. If no action is taken by the User/Broker, the quote remains valid for a pre-determined period of time, after-which the quote, all data, and documents are archived for a process similar to that described above.
   7. In a seventh step, pursuant to the option above where a quote is accepted, the Underwriter determines how to proceed according to the following two step discussions.
a. Request Endorsement from Carrier: The Underwriter sends a request for the endorsement to the Carrier via email or fax. All documentation to accompany the request is selected by the Underwriter. A confirmation is then sent to the User/Broker via the selected method of communication. The request status is changed to In Process—Need Endorsement from Carrier. When returned from the Carrier, the Underwriter can upload the Endorsement to the server. The request status is changed to Action Required—Ready to Send Endorsement. All data is updated in the Broker Application tables so that updated information can be used for renewals.
b. Generate Endorsement: The Underwriter creates the endorsement. The request status is changed to Action Required—Ready to Send Endorsement. All data is updated in the Broker Application tables so that updated information can be used for renewals.
   8. In an eight step, and further to the seventh step above, the Underwriter reviews the Endorsement and sends it to the User/Broker via the selected method of communication. At this step, the request status is changed to “Action Required—Endorsement Sent” and an adobe PDF or other electronic format copy of the endorsement is stored on the server for later use.
   9. In a ninth step, the Underwriter sends all appropriate documentation to the insurance carrier via email, fax, or other convenient means.
   10. In the tenth step, the Endorsement information is sent to internal MGA accounting software provided by a designated software solutions provider for managing Billing and Account purposes.
   11. In an eleventh step, further to the tenth step above the system, sends all documentation on the server to internal MGA software provided by a designated software solutions provider for document Archival purposes. The request status is changed to “Archived” and is no longer viewable in the Underwriter queues.

Endorsement Request System Process

In this section of FIGS. 5A through 5C, and following the steps above, in a first step in the endorsement request system process, an Endorsement Processor (or Clerk) reviews the request and determines whether the request has impact on the policy premium. If not, the Clerk reviews the request and determines if any additional information is needed. If additional information is needed, the Clerk then determines if the information needed is “critical” to the process or is of a more “general nature.
a. Where the information is “Critical”: The Clerk sends a notification to the User/Broker via the selected method of communication requesting information. The request status is changed to Need Critical Info and moved to the In Process queue. The Clerk cannot proceed until the User/Broker updates the request and re-submits to the MGA.
b. Where the information is of a more general nature: the Clerk sends a notification to the User/Broker via the selected method of communication requesting the information in due course. The request status remains in “Other Action Required” to continue processing.
   2. In a second step in the endorsement request system process, the Clerk reviews the endorsement request and has the ability to decline the request if not able to proceed. In this case, the request status is changed to Declined and a notification is sent to the User/Broker via the selected method of communication. All documentation and data is archived after a pre-determined period of time.
   3. In a third step in the endorsement request system process; the Clerk determines how to proceed along the following guild lines:
a. Request Endorsement from Carrier: The Clerk sends a request for the endorsement to the Carrier via email or fax. All documentation to accompany the request is selected by the Clerk. A confirmation is then sent to the User/Broker via the selected method of communication. The request status is changed to “In Process—Need Endorsement from Carrier” and a follow-up record is created to ensure timely response. When returned from the Carrier, the Clerk can upload the Endorsement to the server. The request status is changed to “Other Action Required—Ready to Send Endorsement.” All data is updated in the Broker Application tables so that updated information can be used for renewals.
b. Generate Endorsement: The Endorsement Processor creates the endorsement by selecting the appropriate forms from a list. The information is communicated to integrated software provided by a designated software solutions provider. The endorsement status is changed to “Other Action Required—Ready to Send Endorsement.” All data is updated in the Broker Application tables so that updated information can be used for renewals.
   4. In a fourth step in the endorsement request system process, and further to step three above, the Clerk reviews the Endorsement and sends it to the User/Broker via the selected method of communication. The request status is changed to “Action Required—Endorsement Sent.” An Adobe PDF or other suitable electronic copy of the endorsement is stored on the server to preserve the record for later use.
   5. In a fifth step in the endorsement request system process, and further to step 4 above, the Clerk sends all appropriate documentation the Carrier via email or fax or other suitable communication means.
   6. In a sixth step in the endorsement request system process, and pursuant to the fifth step above, the Endorsement information is sent to internal MGA accounting software provided by a designated software solutions provider for Billing and Account purposes, thereby integrating the entire process into the MGA management system.
   7. In a seventh step in the endorsement request system process, and further to the sixth step above, the overall management system sends all documentation on the server to internal MGA software provided by a designated software solutions provider for document Archival purposes. Thereafter, the request status is changed to Archived and is no longer viewable in the Endorsement Processor queues.

Endorsement Management System Description

The following description covers the broad scope of the endorsement management system according to one preferred embodiment of the present invention. While one selected embodiment is provided, those of skill in the electronic system arts will readily recognize that similar aspects may be provided to users of the system in a different manner without departing from the scope and spirit of the present invention.

A. Endorsement Processor Sign-In:

It is envisioned, that a User ID and Password are required to gain access to the secure system. An administrator creates the Endorsement Processor (Clerk) in the Administration Tool described below. The Sign-In page requires that the Clerk provide their unique User ID and Password. The system verifies entered data with data stored in the database. The Clerk is permitted 3 failed attempts at sign-in after which, the Clerk is there directed to contact technical support for aid in signing in. Upon successful authentication, the Clerk is presented with the Messages page.

B. Endorsement Processor Message Center:

This feature displays any Clerk-specific messages created in the Administration Tool described below. At the top of every page, the counts of the number of applications assigned to the Clerk in each work queue are displayed based on a real-time application status. Work queues are identified as follows:
1. New Requests: This queue displays a list of requests that have either been started by the Clerk or submitted or resubmitted for processing by a User.
2. Create Endorsement: This queue displays a list of all requests for which the User has accepted a Quote and requested that the Clerk create the Endorsement. The Clerk can select the request and begin the Endorsement Creation process.
3. Action Required: This queue displays a list of all requests that require an action. It serves as a catch all for those requests that during the process are in need of attention. The Clerk can select the request and continue processing.
4. In Process: This queue displays a list of all the requests that the Clerk is waiting for an action from another party, such as critical information is requested, the quote has been sent to the User, waiting for a quote from the rating department or Carrier, etc. The Clerk can view the request, or request a follow-up.
5. Follow-up: This queue displays a list of all requests that a request for information was sent and is past due. Clerks can request a follow-up or remove the request for information.

C. Create Endorsement Request

This feature allows the Clerk to create an Endorsement Request if received by email, fax, postal mail, or other suitable means.

D. Quick Find

This feature provides the Clerk with the ability to search for a client based off of Client Name or Phone Number. When a client is found and selected, the Clerk is presented with four tabs as follows:
a. Details—Displays current details about the client including name, address, premises information and loss history. The Clerk has the ability to update the Inspection/Accounting contact information.
b. Policies—Displays current and past Policy documents and Endorsements, viewable in Adobe PDF or other suitable electronic format.
c. Documents—The Clerk can view all pertinent documents associated with the client and also has the ability to upload documents.
d. Notes—Displays all notes associated with each request.

The Clerk also has the ability to add a note to smooth understanding throughout the management system.

E. Reports

This section contains various production reports specific to the Clerk.

F. Change Password

This feature allows the Clerk to change their password.

Renewal Management System

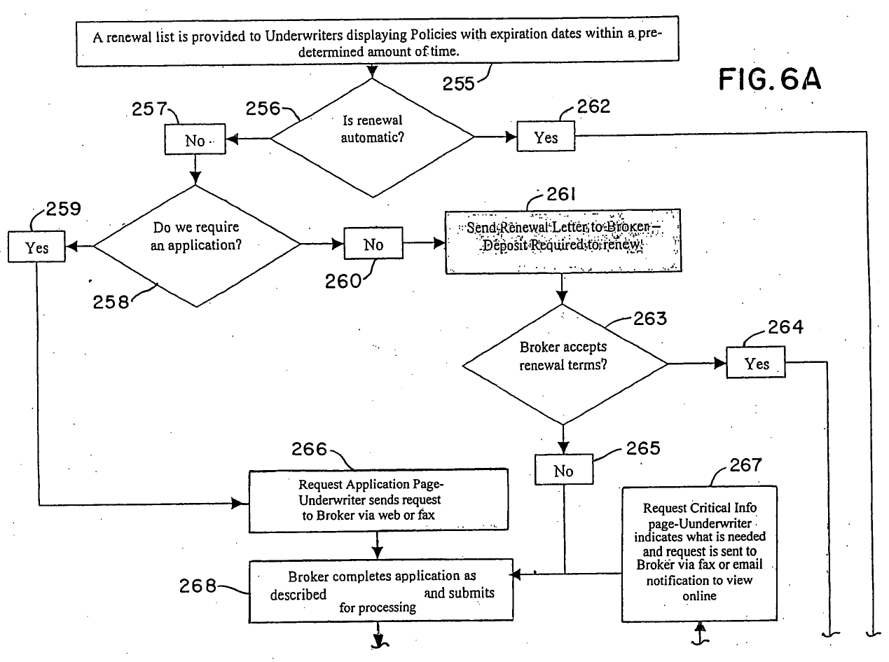

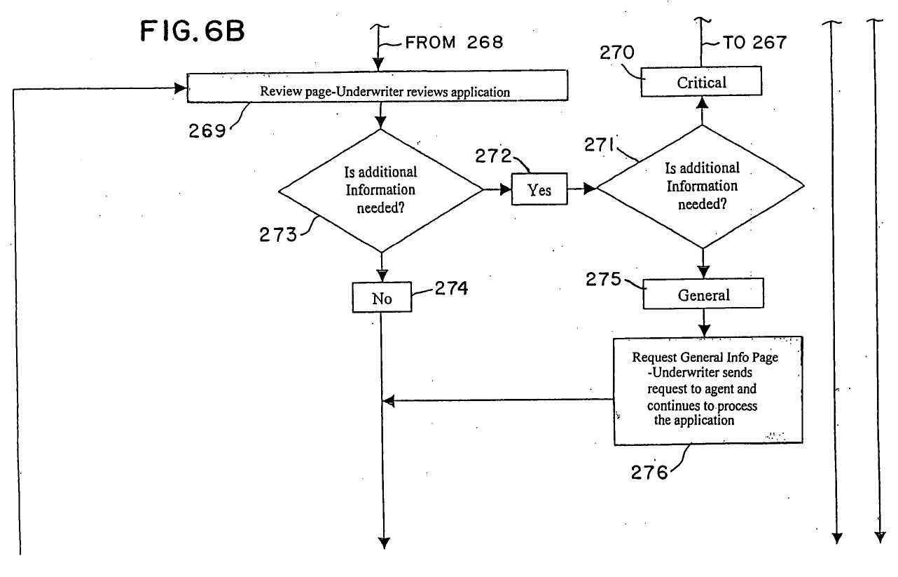

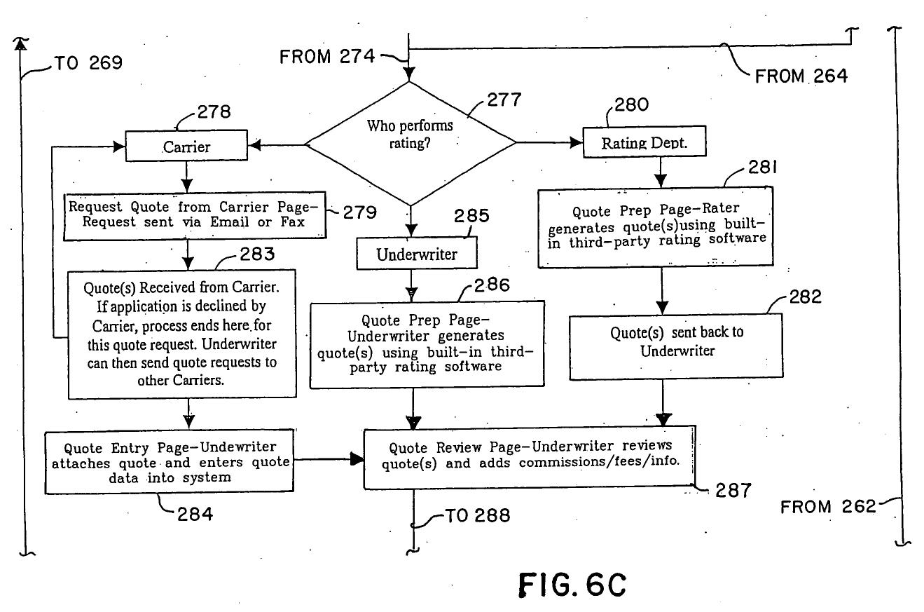

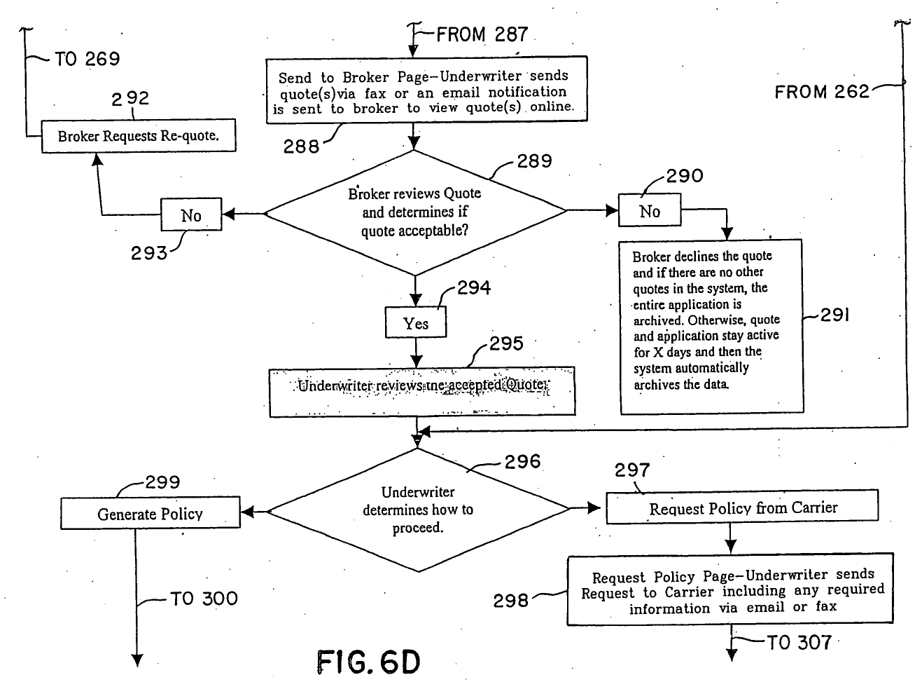

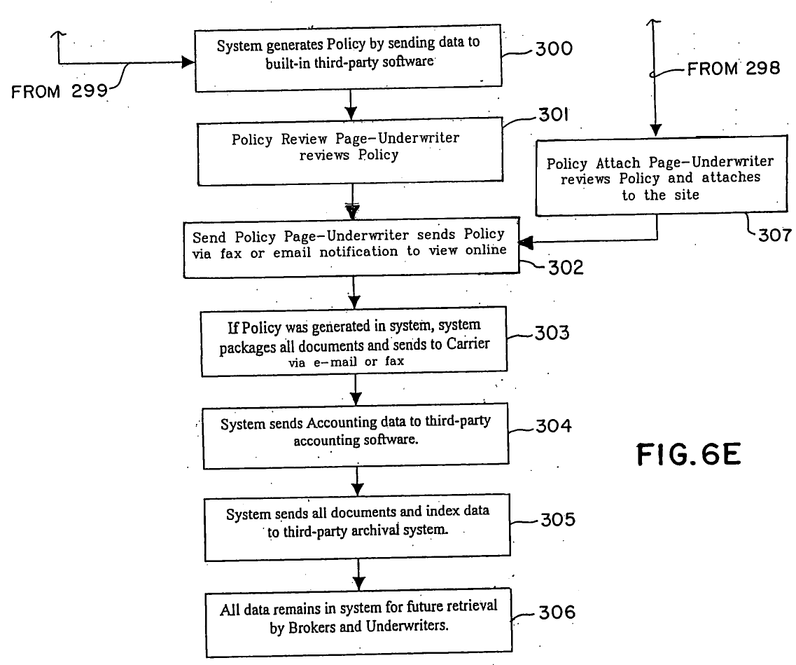

Referring now to FIGS. 6A through FIG. 6C and elements 255 through 307, the broad aspects of the present invention regarding a renewal management system are discussed and illustrated, including the following aspects.

A. Renewal Processor Sign-In

In a proposed renewal processor sign-in, a User ID and Password are required to gain access to the system. An administrator creates the Renewal Processor in the Administration Tool described below. The Sign-In page requires that the Renewal Processor provide their unique User ID and Password. The system verifies entered data with data stored in the database. The Renewal Processor is permitted a variable number of failed attempts at sign-in (proposed as three) after which, the Renewal Processor is directed to contact technical support. Upon successful authentication, the Renewal Processor is presented with the Messages page.

B. Renewal Processor Message Center

As discussed herein, this feature displays any “Renewal Processor” specific messages created in the Administration Tool described below. At the top of every page, the counts of the number of renewals in each work queue are displayed based on a real-time application status. Work queues are designated and identified to aid MGA management as follows:

1. Renewals: This queue displays a list of Policies that require manual renewal processing. (See description below). If there is a non-renewal notice issued from the Carrier, the Renewal Processor will locate the Policy and send it to an Underwriter. The underwriter or renewal processor will have the option to re-quote the renewal with another Carrier, or mark the policy as “dead” from within Underwriter System.

2. Need to Bind: This queue displays a list of all renewals for which the User has accepted a Quote and requested that the Renewal Processor create the Binder and Policy. The Renewal Processor can select the request and begin the Binder process. See Section C 10 below.

3. Action Required: This queue displays a list of all renewals that require an action. It serves as a catch all for those renewals that during the process are in need of attention. The Clerk can select the renewal and continue processing.

4. In Process: This queue displays a list of all the requests that the Renewal Processor is waiting for an action from another party, such as critical information is requested, the quote has been sent to the User, waiting for a quote from the rating department or Carrier, etc. The Renewal Processor can view the request, or request a follow-up.

5. Follow-up: This queue displays a list of all renewals that a request for information was sent and is past due. Renewal Processors can request a follow-up or remove the request for information.

C. Renewal Processing

As discussed herein, the features discussed herein provide a detailed description of the process flow for MGA (management) functions pertaining to processing a Renewal Policy as specifically noted throughout FIGS. 6A through FIG. 6C. As discussed elsewhere herein, one benefit of the present invention is that throughout the process, “system generated notes” are created detailing the date and time each task was completed, who performed the task and what was performed and including any additional tracking information or follow-up type “non-system generated notes.” Additionally, on every selected application page, the MGA is presented with a “control panel” detailing the client's name, the Broker's name and phone number, the Coverage Types, proposed effective and expiration dates, a real-time status, and all supporting documents created during the process (such as Application, Supplemental Applications, Quotes, Binder, etc.) In sum, these system and non-system generated notes and the control panel details provide substantial streamlining throughout the system and a consequential economic and efficiency benefit. The nineteen steps outlined below summarize selected aspects of the present renewal processing system.

1. In a first step, the system automatically determines the renewal process involved (element 255):

a. Automatic Renewal (element 256, 262)—MGA Issue: A Renewal List is compiled and reviewed by the Policy Issuance Department as a management tool. This list displays Policies with expiration dates within a predetermined amount of time and sorted by Carrier.
b. Automatic Renewal—Carrier Issue: The Carrier sends the Renewal Policy to the MGA. The Renewal Processor will locate the Policy within the Renewal List and proceed to step 14 below.
c. Manual Renewal: A Renewal List is compiled and reviewed by the Renewal Processors. When selected a new renewal record is created and the Renewal Processor proceeds to step 2 below.
   2. In a second step, the Renewal Processor determines the next course of action from those noted below:
a. Renewal application required: The Request Renewal Application page is completed by the Renewal Processor and sent to the User/Broker via the selected method of communication. The Renewal status is set at In Process—Waiting for Application.
b. Renewal application not required: Proceed to step 5.
   3. In a third step, pursuant to step 2a above, when the Renewal Application is received from the User/Broker the Renewal Processor reviews and proceeds to the next step. An electronic format copy of the application is saved to the server for later use.

4. In a fourth step, pursuant to step 3 above, if additional information is needed (element 271), the Renewal Processor determines if it is critical to the Rating process or not.
a. Critical: (element 270) The Renewal Processor sends a notification to the Broker via email or fax requesting the information. The Renewal Status is changed to “In Process—Need Information From Broker.” A follow-up record is created and the Renewal Processor cannot proceed until the User/Broker updates the application and re-submits to the MGA. At that point, the Renewal Status is changed to Re-Submitted, after-which the Renewal Processor continues the process as described below.
b. General: (element 275) The Renewal Processor sends a notification to the Broker via the selected method of communication. The Renewal Status remains in Other Action Required to continue processing and a follow-up record is created.
   5. In a fifth step, and further to step four, the Renewal Processor determines if a rating is needed. If the determination is “yes”, the automatic process proceeds to step 6 as noted below, otherwise the automatic process proceeds to step 11.
   6. In a sixth step, and pursuant to optionally steps 2b or 4 above, the Renewal Processor determines who performs the rating functions (element 277):
a. Carrier (element 278)—. The Renewal Processor sends a request to the Carrier to rate the application via email or fax. Accompanying the request is the application information. The Renewal Status is changed to Need Quote from Carrier. When quotes are returned from the Carrier, the Renewal Processor can upload the quotes to the server and enter the quote data into the system. Renewal status is changed to Other Action Required—Ready to Send Quotes. If the Carrier declines the Renewal, the Renewal Processor will remove the request from the system.
b. Rating Department (element 280)—The Renewal Processor sends a request to the MGA Rating Department to rate the application. The Renewal Status is changed to Need Quote—Rater. Subsequently, the Rating Department performs the rating functions using integrated software provided by designated software solutions providers. After rating is complete, the Rating Department sends the quotes back to the Renewal Processor and the application status is changed to Action Required—Ready to Send Quotes.
c. Renewal Processor (element 285)—The Renewal Processor completes a Quote form pre-filled with data from the application and generates quotes using integrated software provided by designated software solutions providers. Renewal Status is changed to Other Action Required—Ready to Send Quotes.
   7. In a seventh step, and further to step 6 above, the Renewal Processor adds all applicable fees, Broker Commissions, and additional information (such as Exclusions, Requirements to Bind, and Supplemental Applications) to the quotes. Those of skill in the art of systems design should note that all supplemental applications as discussed herein, are stored on the system and are dynamically displayed to the User/Broker to print, manipulate, complete, and fax to the Renewal Processor.
   8. In an eighth step, and further to the seventh step above, the Renewal Processor sends the quotes to the User/Broker via the selected method of communication as broadly discussed above. Thereafter, the renewal status is changed to “In Process—Quotes Sent to Broker.”
   9. In a ninth step, and further step eight above, the User/Broker reviews the quote and determines how to proceed according the following logic:
a. If quote is accepted, the User/Broker notifies the Renewal Processor via the web or by fax. The Renewal Status is changed to Accepted Quote. The Broker is required to complete any additional supplemental forms and fax to the Renewal Processor.
b. If quote is unacceptable, the User/Broker can request a re-quote via web or by fax. The Renewal Status is changed to Other Action Required—Re-Quote Requested.
c. If quote is declined by the User/Broker, and no other quotes or quote requests are present, the system will archive all data and documents.
d. If no action is taken by the User/Broker, the quote remains valid for a pre-determined period of time, after-which the quote, all data, and documents are archived.
   10. In a tenth step, and further to step 9b above, the Renewal Processor performs rating functions described in step 6 above.
   11. In an eleventh step, and further to steps 9a or 5 above, the Renewal Processor begins the Binding process. The Renewal Processor creates a Binder based on the information from the quote. If the Broker indicated additions needed to the policy, the Renewal Processor determines how to proceed based on the following criteria:
a. Premium Impacted: If the changes impact the premium, the Renewal Processor makes the changes and sends a Request for Acceptance to the Broker via email notification to view on the web or by fax. The Renewal Status is changed to Quotes Sent to Broker. The Broker reviews the quote as described in 9 above.
b. Non-Premium Impacted: If the changes do not affect the premium, the Renewal Processor makes the changes and continues the process.
   12. In a twelfth step, and further to step eleven, the Renewal Processor indicates whether all supplemental forms have been received from the Broker. Those of skill in the art should note that any supporting documentation received via fax or email can be uploaded to the server via an electronic medium. If documents are still needed, the follow-up uploaded record remains in the system.
   13. In a thirteenth step, and further to step 12 above, the Renewal Processor determines how to proceed according the following options:
a. Request Policy from Carrier: The Renewal Processor sends a request to the Carrier via email or fax to Process the Policy. All documentation to accompany the request is selected by the Renewal Processor. The renewal status is changed to “In Process—Need Policy from Carrier” and a follow-up request is created. When the Policy is received from the Carrier, the Renewal Processor can upload the Policy to the server. The renewal status is changed to Action Required—Ready to Send Policy.
b. Issue Policy Now: The Binder information is communicated to integrated software provided by a designated software solutions provider. The submission status is changed to “Action Required—Ready to Send Policy” and the Renewal Processor is presented with the Policy Review page. Adobe .PDF copies of the Insured's Policy, Broker's Policy, MGA Policy, and Carrier Policy are saved to server.
c. Issue with Delay—The renewal status is changed to In Process—Policy Issuance Department. A follow-up request is created for the Policy Issuance Department. If a change is requested prior to the Policy documents being created, the Renewal Processor can recreate the Binder as detailed in 11 above. If no changes are received prior to a pre-determined period of time, the Policy Issuance Department will create the Policy documents as detailed in 13b above.
   14. In a fourteenth step, and further to step 13a above, the Renewal Processor sends the Policy to the User/Broker via the selected method of communication. The Renewal Status is changed to “Action Required—Policy Sent.” Any updated application data is saved for future processing.
   15. In a fifteenth step, and further to step 1b (automatic renewal) (element 262, 296) above, the Renewal Processor will update the Policy data and send the Policy to the User/Broker via the selected method of communication. Renewal status is set to “Action Required—Policy Sent.”
   16. In a sixteenth step, and further to step 15 above, the Renewal Processor sends all appropriate documentation the Carrier via email or fax.
   17. In a seventeenth step, and further to step 16 above, the Renewal Processor determines if an Inspection request is needed. If yes, the Renewal Processor completes an Inspection Request form and sends the request via fax or system communicates directly via the web with Inspection Services Providers. A follow-up record is automatically and electronically created enabling further management capabilities.
   18. In a seventeenth step, and further to step 17 above, Renewal Policy information are sent to internal MGA software provided by a designated software solutions provider for Billing and Account purposes.
   19. In a nineteenth step, and further to step 18 above, the system sends all documentation on the server to internal MGA software provided by a designated software solutions provider for document Archival purposes.

D. Quick Find

As discussed previously, and as will be understood by those of skill in the software and system designing arts, a quick find feature is an additional process management tool that minimizes costs, and speeds completion. This quick find feature provides the Renewal Processor with the ability to search for a client based off of Client Name or Phone Number or portions of both. Thereafter, when a client is found and selected, the Renewal Processor is presented with four display/selection tabs as follows. These tabs provide easy complete access to the essential information for processing, thereby further speeding operations.

The selection/display tabs include:
a. Details—Displays current details about the client including name, address, premises information and loss history. The Renewal Processor has the ability to update the Inspection/Accounting contact information.
b. Policies—Displays current and past Policy documents and Endorsements, viewable in Adobe .PDF format.
c. Documents—The Renewal Processor can view all pertinent documents associated with the client and also has the ability to upload documents.
d. Notes—Displays all notes associated with each submission. The Renewal Processor also has the ability to add a note.

E. Other Users Queues

While not visually described, those of skill in the art will understand this option and feature to provides the ability for an Renewal Processor to process applications that are assigned to another Renewal Processor that is flagged as being Out-Of-Office, or otherwise unavailable for processing. See Settings below in section G.

F. Reports

As discussed herein, it is envisioned that this section contains various production reports specific to the Renewal Processor that may be created to serve a user's demands. These reports may be tabular, in writing, and may be selectively format-able by a user to parse the raw production data in to a useable form, including by date, time, user, client, due time, delay range, etc.

F. Settings

As presently envisioned, this feature contains two sections. The first section allows the Renewal Processor to set them selves as being Out-Of-Office (on lunch leave, sick, training, etc.) so that other Renewal Processors can work the out-of-office processors' work queues and thereby manage work flow for speedy handing of process bottlenecks, rush works, and detection of growing management problems. The second section is the ability for the Renewal Processor to upload an image of their signature to the server to appear on appropriate documents and so create fully executed and signature-authorized files.

Administration Tools

In view of the entire process and system disclosure above, those of skill in the art should recognize that the present invention provides multiple features and benefits that are both responsive to at least one of the needs noted above and supportive of at least one of the objects of the present invention. The below paragraphs summarize select ones of these features and benefits with additional discussion.

A. System Administrator Sign-in

A User ID and Password are required to gain access to the system. An administrator creates the System Administrator in the Administration Tool described below. The Sign-In page requires that the System Administrator provide their unique User ID and Password. The system verifies entered data with data stored in the database. The System Administrator is permitted multiple but a determined number of failed attempts at sign-in after which, the System Administrator is directed to contact technical support. Upon successful authentication, the System Administrator is presented with the Administration Tool Home page.

B. User Management As discussed and enabled above, and as should be understood by those of skill in the art, the User Management features discussed herein allow one or more System Administrators in the Managing General Agency (MGA) to manage each aspect of the “Users” for each section of the entire system, as discussed below. While the “Users” tasks, roles, and levels of responsibility vary, it is proposed that the present overall system enables substantial flexibility and commonality of operation that greatly increases efficiency and swift receipt, analysis, and issuance of insurance or other products.

It is specifically noted herein, that the present system is tailored to the generalized insurance application process, but may be readily adapted to manage other multi-task and complex software-capable operations.

As noted above, the “Users” of the entire systems discussed include, but are not necessary limited to in modified embodiments, the following:
a. Brokers: The System Administrator can update Broker User ID and email information, reassign the Broker to a different Company, change Company Administrators and revoke access to the system. Additionally, the System Administrator can reset the Broker's password.
b. Underwriters: The System Administrator can add or update Underwriter information, assign the Underwriter to a specific Branch, identify the Underwriter as an Assistant, and set the Underwriter Out of Office status. Additionally, the System Administrator can reset the Underwriter's password or revoke access to the system.
c. Raters: The System Administrator can add or update Rater information, assign the Rater to a specific Branch, and set the Rater Out of Office status. Additionally, the System Administrator can reset the Rater's password or revoke access to the system.
d. Clerks: The System Administrator can add or update Clerk information, assign the Clerk to a specific Branch, and set the Clerks Out of Office status. Additionally, the System Administrator can reset the Clerk's password or revoke access to the system.
e. Renewal Processors: The System Administrator can add or update Renewal Processor information, assign the Renewal Processor to a specific Branch, and set the Renewal Processors Out of Office status. Additionally, the System Administrator can reset the Renewal Processor's password or revoke access to the system.
f. System Administrators: The System Administrator can add or update System Administrators information and reset the System Administrator's password or revoke access to the system.
g. Company/Agency Management: The system Administrator can add or update Company/Agency information, reassign the company to a different Branch and identify whether the company is registered for access to the system. Setting this flag will determine if communications are done via fax or email.

C. Client Servicing

As earlier noted, this feature allows System Administrators to search for and view an entire client record, including all historical and current documentation, those who worked on each aspect, etc. All correspondence and notes are also viewable as is all contact information. All client information is updateable and selected authorized users may modify other aspects of the present system. In sum, the aspect of client servicing and multiple access with transparent location enables a substantial increase in client service benefits and clearance of previously troubling and difficult applications.

D. Technical Support

As earlier discussed, all technical support items submitted as described in the Broker Section above are displayed upon request of the System Administrators to view and respond to. Administrators can communicate these to a software or integrated software service provider (for example Single Entry Systems, Inc.) for assistance or resolve these items as necessary, after-which an email notification is sent to the Broker managing the selected process. The electronic suggestion box is also located in this section within the Technical Support section, and previously selected electronic suggestions can be reviewed as well as track for later completion and review.

E. Document Management

As noted earlier, this feature allows the System Administrator to maintain the document library for static documents used during the application process. The System Administrator can upload the documents and identify their usage within the system. Example of documents would Carrier specific Supplemental Applications and Anti-Arson Applications.

F. Carrier Management

This feature allows the System Administrator to Add and Update Carrier specific information such as Address, contact information.

G. Reports

This feature allows System Administrators to produce numerous User, Usage, Client, Broker, Branch, Department and Policy specific reports.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A system for providing a real-time single-entry, multiple company interface (SEMCI) allowing users to complete applications for insurance as managed by a Managing General Agency (MGA), the system configured to:
provide an automated user registration and authentication process supplying a unique-user identification and validation system to a user;
said automated user registration process includes an automated unique-user tracking apparatus and means for enabling said unique-user tracking apparatus to link said user to each action of said user for an improved system management;
said automated user registration process including means for linking a broker company to said unique-user identification prior to an authentication of said user as a broker;
provide an automated user application creation and submission process for supplying insurance submission data and for creating and submitting an insurance endorsement request application to an underwriter for review;
provide a means for automating a submission management process for analyzing and underwriting an insurance endorsement request application submitted to an underwriter for review;
said means for automating a submission management process further including means for conducting a rating of said insurance endorsement request;
said means for conducting a rating including means for conducting one of an automated and a manual rating of said insurance endorsement request; and
provide a means for automatically enabling said underwriter to transmit said insurance endorsement request to said broker following a rating result and an endorsement of said insurance request.

2. A system for providing a real-time single-entry, multiple company interface (SEMCI) allowing users to complete applications for insurance as managed by a Managing General Agency (MGA), the system according to claim 1 wherein:
said submission management process includes means for an underwriter to designate additional application information as needed;
said additional application information being categorized as critical or general application information, whereby missing said critical application information prohibits said system from further action on said application for insurance thereby improving an accuracy and a speed of said system.

3. A system for providing a real-time single-entry, multiple company interface (SEMCI) allowing users to complete applications for insurance as managed by a Managing General Agency (MGA), the system according to claim 1 configured to:
contain means for generating at least one of a system generated note and a non-system generated note at each action along a complete application chain;
said at least one note being generated by an action of at least one of a user, and underwriter, and a broker; whereby said at least one generated note is electronically linked with said action of said at least one and reviewable at least said underwriter thereby enabling said underwriter to be informed of selected application information notes during an underwriting process.

4. A system for providing a real-time single-entry, multiple company interface (SEMCI) allowing users to complete applications for insurance as managed by a Managing General Agency (MGA), the system according to claim 1 configured to:
contain means for generating and updating a control panel system providing selectable options to one of said underwriter and said broker to track a process during said underwriting

5. A system for providing a real-time single-entry, multiple company interface (SEMCI) allowing users to complete applications for insurance as managed by a Managing General Agency (MGA), the system according to claim 1 configured to:
provide an endorsement request processing system for managing an underwriter system processing system and for tracking and generating management data for tracking said underwriter system.

6. A system for providing a real-time single-entry, multiple company interface (SEMCI) allowing users to complete applications for insurance as managed by a Managing General Agency (MGA), the system according to claim 1 configured to:
provide an application renewal processing system including means for receiving a renewal request and for conducting one of an automatic renewal and a non-automatic renewal, whereby said system substantially automates a renewal process.
